(19) United States
(12) Patent Application Publication
(10) Pub. No.: US 2024/0003662 A1
(43) Pub. Date: Jan. 4, 2024

(54) SUBSTRATE OF VARIABLE INFRARED EMISSIVITY

(71) Applicant: The University of Manchester, Manchester Greater Manchester (GB)

(72) Inventors: Coskun Kocabas, Manchester Greater Manchester (GB); Muhammed Said Ergoktas, Manchester Greater Manchester (GB); Gokhan Bakan, Manchester Greater Manchester (GB)

(21) Appl. No.: 18/254,748

(22) PCT Filed: Nov. 30, 2021
(86) PCT No.: PCT/GB2021/053116

§ 371 Date: May 26, 2023

(30) Foreign Application Priority Data
Nov. 30, 2020 (GB) 2018853.8

(51) Int. Cl. F41H 3/02; B32B 3/14; B32B 9/04

(52) U.S. Cl. CPC F41H 3/02; B32B 3/14; B32B 9/047; B32B 2307/20

(57) ABSTRACT

The present invention relates to a substrate having a surface of variable infrared emissivity, wherein at least one surface of the substrate comprises a plurality of pendent composite sheets fixed thereto. The present invention also relates to methods of varying the infrared emissivity on a surface of a substrate and its uses in dynamic thermal management, camouflage technology infrared communication and as a heat regulating protective cover.

### INTRODUCTION

The present invention relates to a substrate having a surface of variable infrared emissivity. The present invention also relates to methods of varying the infrared emissivity of a surface of a substrate and the application of such substrates and methods to dynamic thermal management, camouflage technology/infrared communication and heat regulation.

### BACKGROUND OF THE INVENTION

Infrared radiation is a form of thermal electromagnetic radiant energy which has wavelengths longer than those of visible light but shorter that those of radio waves. Even though infrared radiation is not visible to the human eye, its thermal energy can be felt in the form of heat transfer. When infrared radiation is emitted from the sun, for example, which gives off half of its total energy as infrared radiation, the energy is absorbed by objects which are close enough to receive the energy and can subsequently emit the infrared radiation. The level of infrared emission is dependent on the molecules which are excited by the infrared radiation and how they change their rotational-vibrational movements as a result of the excitation. Objects will emit varying amounts of infrared radiation depending on how the molecules react when excited.

This understanding has resulted in a number of applications in everyday life which utilise infrared radiation. For example, toasters, heat lamps and incandescent bulbs all use infrared radiation to transmit heat energy for their respective function. Arguably, however, the most useful application has been infrared sensing, which utilises the infrared radiation emitted from almost every object on earth (albeit in various amounts) for detection and communication. Technology, such as infrared and night-vision cameras, can detect changes in infrared radiation of an object by using imaging chips which are infrared sensitive. In essence, the camera detects the infrared energy of objects and converts that data into an image on the basis of the apparent surface temperature of the object. In certain applications, such as friend or foe identification in which communication is of critical importance, it may be desirable to modify and even tune a surface of an object to control the infrared emissivity that is being detected. Not only would tunability of infrared radiation prove useful for identification and communication purposes, this technology may also be particularly useful for thermal control. Indeed, controlling the infrared emissivity of a surface of an object would provide an effective means of heat regulation of said object, removing the need for any external sources of thermal energy, such as a heating or cooling apparatus.

In view of the above, there is a need for a material with variable and controllable infrared emissivity and a method for controlling the infrared emissivity such that the tunability provided can be exploited in a number of identification, communication and heat regulation applications.

The present invention was devised with the foregoing in mind.

### SUMMARY OF THE INVENTION

According to a first aspect of the present invention there is provided a substrate having a surface of variable infrared emissivity, wherein at least one surface of the substrate comprises a plurality of pendent composite sheets fixed thereto, and wherein each pendent composite sheet comprises a first surface of higher infrared emissivity and a second surface of lower infrared emissivity, and wherein each pendent composite sheet is independently fixed to the substrate and configured such that each sheet can be moved between a first position in which the first surface of higher infrared emissivity covers a portion of the surface of the substrate and a second position in which the second surface of lower infrared emissivity covers a portion of the surface of the substrate.

According to a second aspect of the present invention there is provided an object or article having a surface coated with a substrate having a surface of variable infrared emissivity according to the first aspect of the present invention.

According to a third aspect of the present invention there is provided a method of varying the infrared emissivity on a surface of a substrate according to the first aspect of the present invention, the method comprising moving one or more pendent composite sheets between a first position in which the first surface of higher infrared emissivity covers a portion of the surface of the substrate and a second position in which the second surface of lower infrared emissivity covers a portion of the surface of the substrate, or vice versa.

According to a fourth aspect of the present invention there is provided a use of a substrate according to the first aspect of the present invention for dynamic thermal management by controlling the infrared emissivity of the surface of a substrate, wherein the use for dynamic thermal management by controlling the infrared emissivity of the surface of a substrate is according to the method of the third aspect of the present invention.

According to a fifth aspect of the present invention there is provided a use of a substrate according to the first aspect of the present invention for camouflage technology infrared communication, wherein the use for camouflage technology infrared communication is according to the method of the third aspect of the present invention.

According to a sixth aspect of the present invention there is provided a use of a substrate according to the first aspect of the present invention as a heat regulating protective cover, wherein the use for heat regulating protective covers is according to the method of the third aspect of the present invention.

### DETAILED DESCRIPTION OF THE INVENTION

### Substrate of Variable Infrared Emissivity

In a first aspect of the present invention there is provided a substrate having a surface of variable infrared emissivity, wherein at least one surface of the substrate comprises a plurality of pendent composite sheets fixed thereto, and wherein each pendent composite sheet comprises a first surface of higher infrared emissivity and a second surface of lower infrared emissivity, and wherein each pendent composite sheet is independently fixed to the substrate and configured such that each sheet can be moved between a first position in which the first surface of higher infrared emissivity covers a portion of the surface of the substrate and a second position in which the second surface of lower infrared emissivity covers a portion of the surface of the substrate.

Through detailed investigations, the inventors have found that the substrates disclosed herein surprisingly offer a wealth of applications in everyday use, defence technology and outer space technology. In particular, the controllability of the infrared emissivity makes the substrates of the present invention ideally suited for building covers, car covers, satellite covers and friend or foe identification, amongst a myriad of other applications in which controlling infrared emissivity is functionally important. As discussed hereinbefore, the substrates of the present invention offer controllability of infrared emissivity meaning that it is possible to regulate the temperature of objects in which the substrates cover or partially cover. In particular, it has been found that heat regulation is possible for buildings, cars and satellites when the substrates cover or partially cover these objects. The controllability of infrared emissivity offered by these substrates also allows for communication and identification applications by the methods of changing the infrared emissivity of the substrate as described herein. For example, when viewed through infrared sensitive detectors such as night vision cameras, the substrates can identify a friend or foe by varying the infrared emissivity of the substrate and can also communicate to the infrared sensitive detector by sending messages based on infrared emissivity which would be understood by the infrared sensitive detector. As a consequence, the substrates of the present invention are also particularly useful in a number of identification and communication applications in the defence sector.

In a particular embodiment of the present invention, the substrate is selected from the group consisting of textiles, non-woven textiles, fabric, polymeric material, a surface of an object or article, and a combination thereof. It will be appreciated that any of the aforementioned substrates will be suitable for the pendent composite sheets of the present invention, which are to be fixed thereto, thereby providing a surface with variable infrared emissivity. In a particularly suitable embodiment of the present invention, the substrate is selected from the group consisting of textiles, non-woven textiles, fabric, polymeric material and a surface of an object or article. More suitably, the substrate is a fabric. It may be envisaged that any suitable fabric may be selected as the substrate. In particular embodiments wherein the substrate is a fabric, the fabric is selected from the group consisting of cotton, polyester, nylon and cloth.

It may be envisaged that the substrate is a fabric and is selected from the group consisting of cotton, polyester, nylon and cloth, and is particularly suited for completely or partially covering another object. For example, in an embodiment the substrates of the present invention can be specifically designed so that they can completely or partially cover an object of any size, such as a human, a car, a building or a satellite.

In embodiments wherein the substrate of the present invention completely or partially covers an object such as a human, a car, a building or a satellite, the infrared emissivity of the object covered or partially covered will be controlled by the pendent composite sheets fixed to the substrate of the present invention, each of which comprises a first surface of higher infrared emissivity and a second surface of lower infrared emissivity. By controlling the infrared emissivity, the object covered or partially covered by the substrate of the present invention may be thermally regulated. Alternatively, by controlling the infrared emissivity, the object covered or partially covered by the substrate of the present invention may communicate with an infrared detector focused on the object, useful in, for example, friend or foe identification and defence technology.

### Pendent Composite Sheets

As discussed hereinbefore, at least one surface of the substrate of the present invention comprises a plurality of pendent composite sheets fixed thereto, thereby allowing the at least one surface of the substrate to have variable infrared emissivity.

In an embodiment each pendent composite sheet is independently fixed to the substrate by a thread, a hook, a linker, a hinge, sewing means or a connecting member. Suitably, each pendent composite sheet is independently fixed to the substrate by a thread, sewing means, a hook or a hinge. More suitably, each pendent composite sheet is independently fixed to the substrate by a thread or by sewing means. In such embodiments wherein each pendent composite sheet is independently fixed to the substrate by a thread, it is possible for the thread to sew the pendent composite sheet to the substrate. In such embodiments, each pendent composite sheet may comprise at least one hole through which a thread can be sewn.

The plurality of pendent composite sheets fixed to the substrates of the present invention allow for the infrared emissivity of the substrates to be varied. Such control is achieved by moving the pendent composite sheets which comprise a first surface of higher infrared emissivity and a second surface of lower infrared emissivity.

### First Surface of Higher Infrared Emissivity

In an embodiment, each pendent composite sheet comprises a first surface of higher infrared emissivity, wherein the first surface of higher infrared emissivity comprises any suitable material which is of higher infrared emissivity. Suitably, the first surface of higher infrared emissivity is coated with/comprises at least one material selected from the group consisting of polymeric materials, fabrics, graphene and/or a dielectric layer of higher infrared emissivity.

In a preferred embodiment, each pendent composite sheet comprises a first surface of higher infrared emissivity, wherein the first surface of higher infrared emissivity is coated with/comprises a polymeric material. It will be appreciated that any suitable polymeric material may be used. Suitably, the polymeric material is selected from the group consisting of polyvinylchloride, polyethylene terephthalate, polyethylene, polypropylene, polystyrene, Nylon, Teflon, polyurethanes, polychlorotrifluoroethylene, poly(methyl methacrylate) (also known as acrylic or plexiglass), polydimethylsiloxane, poly-para-xylylene (hereafter referred to as Parylene), glass and combinations thereof. More suitably, the polymeric material is selected from the group consisting of polyvinylchloride, polyethylene terephthalate, polyethylene, polypropylene, polystyrene, Nylon and Teflon. Even more suitably, the polymeric material is polyethylene terephthalate.

In a particular preferred embodiment, each pendent composite sheet comprises a first surface of higher infrared emissivity, wherein the first surface of higher infrared emissivity is coated with/comprises a fabric. It will be appreciated that any suitable fabric may be used. Suitably, the fabric is selected from the group consisting of cotton, polyester, silk and a combination thereof.

In an embodiment wherein the first surface of higher infrared emissivity is coated with/comprises at least one material selected from the group consisting of polymeric materials and/or fabrics, the coating on the first surface of higher infrared emissivity has a thickness of 1-300 μm. Suitably, the coating on the first surface of higher infrared emissivity has a thickness of 20-200 μm. More suitably, the coating on the first surface of higher infrared emissivity has a thickness of 40-100 μm. Even more suitably, the coating on the first surface of higher infrared emissivity has a thickness of 60-80 μm.

In another preferred embodiment each pendent composite sheet comprises a first surface of higher infrared emissivity, wherein the first surface of higher infrared emissivity is coated with/comprises graphene. Graphene is the name given to a particular crystalline allotrope of carbon in which each carbon atom is bound to three adjacent carbon atoms (in a sp 2 hybridised manner) so as to define a one atom thick planar sheet of carbon. The carbon atoms in graphene are arranged in the planar sheet in a honeycomb-like network of tessellated hexagons. Graphene can be formed by exfoliation of graphite. In particular embodiments wherein the first surface of higher infrared emissivity is coated with/comprises graphene, the graphene has a thickness of 1.9-95 nm. Suitably, the graphene has a thickness of 3.8-85.5 nm. More suitably, the graphene has a thickness of 5.7-76 nm. Even more suitably, the graphene has a thickness of 7.6-66.5 nm. Yet even more suitably, the graphene has a thickness of 9.5-57 nm.

It will be appreciated that if each pendent composite sheet comprising a first surface of higher infrared emissivity, wherein the first surface of higher infrared emissivity is coated with/comprises graphene, the thickness may be expressed in the number of layers of graphene. In an embodiment the graphene has a thickness of 5-250 layers of graphene. Suitably, the graphene has a thickness of 10-225 layers of graphene. More suitably, the graphene has a thickness of 15-200 layers of graphene. Even more suitably, the graphene has a thickness of layers of graphene. Yet more suitably, the graphene has a thickness of 25-150 layers of graphene.

In another preferred embodiment each pendent composite sheet comprises a first surface of higher infrared emissivity, wherein the first surface of higher infrared emissivity is coated with/comprises a dielectric layer of higher infrared emissivity. A dielectric layer of higher infrared emissivity will be understood to comprise at least one metal layer, at least one polymeric material layer and at least one tuneable layer. It may be envisaged that any suitable metal may be used. In an embodiment, the at least one metal layer may comprise gold, silver, aluminium, copper, nickel, steel, titanium, chromium, platinum and/or iron. It may be envisaged that any suitable polymeric material may be used. In an embodiment, the at least one polymeric material layer may comprise polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene and/or glass. Typically, the dielectric layer is configured to have a tuneable layer as the outer layer, a polymer as the intermediate layer, and an underlying metal forming the base layer. The at least one tuneable layer will be understood to control the infrared emissivity of the dielectric layer of higher infrared emissivity. The tuneability of the infrared emissivity is controlled by the thickness of the at least one tuneable layer. In an embodiment the at least one tuneable layer has a thickness of 1-20 nm. Suitably, the at least one tuneable layer has a thickness of 1.5-10 nm. More suitably, the at least one tuneable layer has a thickness of 2-5 nm. Yet more suitably, the at least one tuneable layer has a thickness of 3 nm. In an embodiment the at least one tuneable layer may comprise a metal selected from the group consisting of gold, silver, copper, platinum, rhodium, ruthenium, osmium, iridium and palladium.

### Second Surface of Lower Infrared Emissivity

As discussed hereinbefore, the pendent composite sheets of the present invention comprise a first surface of higher infrared emissivity and a second surface of lower infrared emissivity and are fixed to the substrate such that the substrate has a surface of variable infrared emissivity. In an embodiment, each pendent composite sheet comprises a second surface of lower infrared emissivity, wherein the second surface of lower infrared emissivity comprises any suitable material which is of lower infrared emissivity. Suitably, the second surface of lower infrared emissivity is coated with/comprises at least one material selected from the group consisting of metals, metal foils, conductive oxides, graphene and/or a dielectric layer of lower infrared emissivity.

In a preferred embodiment, each pendent composite sheet comprises a second surface of lower infrared emissivity, wherein the second surface of lower infrared emissivity is coated with/comprises a metal or a metal foil. It will be understood that the term metal foil represents a thin sheet of metal, typically made from a hammering or rolling process, although the metal foils of the present invention are not limited to fabrication from just these processes. A metal foil fabricated from any process may be used. It may be envisaged that any suitable metal or metal foil may be used. Suitably, the metal or metal foil is selected from the group consisting of gold, silver, aluminium, copper, nickel, steel, titanium, chromium, platinum and iron. More suitably the metal or metal foil is selected from the group consisting of gold, silver and aluminium. Even more suitably, the metal or metal foil is selected from the group consisting of gold and aluminium. In certain preferred embodiments, the metal or metal foil is gold. In certain other preferred embodiments, the metal or metal foil is aluminium.

In another preferred embodiment, each pendent composite sheet comprises a second surface of lower infrared emissivity, wherein the second surface of lower infrared emissivity is coated with/comprises a conductive oxide. It may be envisaged that any suitable conductive oxide may be used. Suitably, the conductive oxide is selected from the group consisting of indium tin oxide and fluorine tin oxide. More suitably, the conductive oxide is indium tin oxide.

In an embodiment wherein the second surface of lower infrared emissivity is coated with/comprises at least one material selected from the group consisting of metals, metal foils and/or conductive oxides, the coating on the second surface of lower infrared emissivity has a thickness of 1-20000 nm. Suitably, the coating on the second surface of lower infrared emissivity has a thickness of 10-10000 nm. More suitably, the coating on the second surface of lower infrared emissivity has a thickness of 100-9000 nm. Yet more suitably, the coating on the second surface of lower infrared emissivity has a thickness of 500-7000 nm. Yet even more suitably, the coating on the second surface of lower infrared emissivity has a thickness of 1000-5000 nm.

In another preferred embodiment, each pendent composite sheet comprises a second surface of lower infrared emissivity, wherein the second surface of lower infrared emissivity is coated with/comprises graphene. Suitably, the graphene has a thickness of 28.5-570 nm. More suitably, the graphene has a thickness of 38-475 nm. Even more suitably, the graphene has a thickness of 47.5-380 nm. Yet more suitably, the graphene has a thickness of 57-285 nm. Yet even more suitably, the graphene has a thickness of 76-190 nm. While a range of graphene thickness has been discussed hereinbefore, the upper range of the graphene thickness may go beyond 570 nm and is not limited thereto.

It will be appreciated that if each pendent composite sheet comprising a second surface of lower infrared emissivity, wherein the second surface of lower infrared emissivity is coated with/comprises graphene, the thickness may be expressed in the number of layers of graphene. In an embodiment the graphene has a thickness of 75-1500 layers of graphene. Suitably, the graphene has a thickness of 100-1250 layers of graphene. More suitably, the graphene has a thickness of 125-1000 layers of graphene. Even more suitably, the graphene has a thickness of 150-750 layers of graphene. Yet more suitably, the graphene has a thickness of 200-500 layers of graphene. While a range of graphene thickness has been discussed hereinbefore, the upper range of the graphene thickness may go beyond 1500 layers of graphene and is not limited thereto.

In embodiments wherein the first surface of higher infrared emissivity comprises graphene and the second surface of lower infrared emissivity also comprises graphene, it will be understood that the thickness of the graphene in or on the first surface of higher infrared emissivity is relative to the thickness of the graphene in or on the second surface of lower infrared emissivity. Therefore, in an embodiment wherein the first surface of higher infrared emissivity is coated with/comprises graphene and the second surface of lower infrared emissivity also is coated with/comprises graphene, the graphene in or on the first surface of higher infrared emissivity has a thickness which is less than the thickness of graphene in or on the second surface of lower infrared emissivity. It will therefore be understood that in an embodiment wherein the first surface of higher infrared emissivity is coated with/comprises graphene and the second surface of lower infrared emissivity also is coated with/comprises graphene, the graphene in or on the second surface of lower infrared emissivity has a thickness which is greater than the thickness of graphene in or on the first surface of higher infrared emissivity. It may therefore be envisaged that when the first surface of higher infrared emissivity is coated with/comprises graphene and the second surface of lower infrared emissivity also is coated with/comprises graphene, the graphene in or on the first surface of higher infrared emissivity may have a thickness of 100 layers of graphene and the graphene in or on the second surface of lower infrared emissivity may have a thickness of 200 layers of graphene. It may equally be envisaged that when the first surface of higher infrared emissivity is coated with/comprises graphene and the second surface of lower infrared emissivity also is coated with/comprises graphene, the graphene in or on the first surface of higher infrared emissivity may have a thickness of 50 layers of graphene and the graphene in or on the second surface of lower infrared emissivity may have a thickness of 100 layers of graphene.

In another preferred embodiment each pendent composite sheet comprises a second surface of lower infrared emissivity, wherein the second surface of lower infrared emissivity is coated with/comprises a dielectric layer of lower infrared emissivity. A dielectric layer of lower infrared emissivity will be understood to comprise at least one metal layer, at least one polymeric material layer and at least one tuneable layer. It may be envisaged that any suitable metal may be used. In an embodiment, the at least one metal layer may comprise gold, silver, aluminium, copper, nickel, steel, titanium, chromium, platinum and/or iron. It may be envisaged that any suitable polymeric material may be used. In an embodiment, the at least one polymeric material layer may comprise polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene and/or glass. Typically, the dielectric layer is configured to have a tuneable layer as the outer layer, a polymer as the intermediate layer, and an underlying metal forming the base layer. The at least one tuneable layer will be understood to control the infrared emissivity of the dielectric layer of lower infrared emissivity. The tuneability of the infrared emissivity is controlled by the thickness of the at least one tuneable layer. In an embodiment the at least one tuneable layer has a thickness of 0-0.9 nm. Suitably, the at least one tuneable layer has a thickness of 0-0.5 nm. More suitably, the at least one tuneable layer has a thickness of 0-0.25 nm. Yet more suitably, the at least one tuneable layer has a thickness of 0-0.1 nm. In an embodiment the at least one tuneable layer may comprise a metal selected from the group consisting of gold, silver, copper, platinum, rhodium, ruthenium, osmium, iridium and palladium.

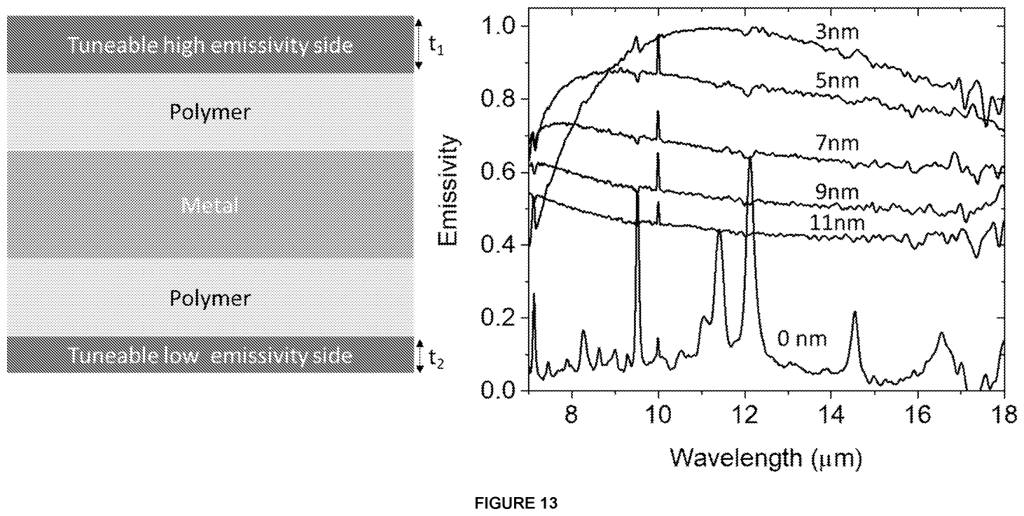

In certain embodiments, the first surface of higher infrared emissivity is coated with/comprises a dielectric layer of higher infrared emissivity and the second surface of lower infrared emissivity is coated with/comprises a dielectric layer of lower infrared emissivity. In such embodiments, the dielectric layers may be applied to a surface of a substrate. Alternatively, the base layer of the dielectric layer may be common to both the surface of higher infrared emissivity and the surface of lower infrared emissivity, as shown in FIG. 13. For example, in embodiments wherein the dielectric layer has a tuneable layer as the outer layer, a polymer as the intermediate layer, and an underlying metal forming the base layer, the base layer may be common to both dielectric layers.

Therefore, in an embodiment wherein the first surface of higher infrared emissivity is coated with/comprises a dielectric layer of higher infrared emissivity and the second surface of lower infrared emissivity is coated with/comprises a dielectric layer of lower infrared emissivity, the following configuration is possible:
I. a tuneable layer coated on the surface of a polymeric layer, with a thickness of, for example, 0.1 nm;
II. a polymeric layer, such as Parylene, which has a thickness of ¼ of the desired wavelength (typically 2.5 μm);
III. a metal as defined hereinbefore, such as aluminium;
IV. a polymeric layer, such as Parylene, which has a thickness of ¼ of the desired wavelength (typically 2.5 μm); and
V. a tuneable layer coated on the surface of the polymeric layer, with a thickness of, for example, 3 nm.

In this embodiment, the tuneable layer is applied to the polymeric layers at different thicknesses for each dielectric layer. This has the effect of tuning both the first surface of higher infrared emissivity to a higher infrared emissivity value (3 nm tuneable layer, for example) and the second surface of lower infrared emissivity to a lower infrared emissivity value (0.1 nm tuneable layer, for example).

### Adhesion Layer

In an embodiment, each pendent composite sheet of the present invention may comprise an adhesion layer positioned between the layers forming the first surface of higher infrared emissivity and the second surface of lower infrared emissivity of the pendent composite sheet. Suitably the adhesion layer has a thickness of 1-10 nm. More suitably, the adhesion layer has a thickness of 2-8 nm. Even more suitably, the adhesion layer has a thickness of 3-7 nm. Yet even more suitably, the adhesion layer has a thickness of 5 nm.

In an embodiment wherein each pendent composite sheet comprises an adhesion layer, any suitable adhesion layer may be used. Suitably, in embodiments wherein each pendent composite sheet comprises an adhesion layer, the adhesion layer may comprise chromium or titanium. More suitably, the adhesion layer comprises titanium. Yet more suitably, the adhesion layer comprises chromium. It will be appreciated that the adhesion layer positioned between the layers forming the first surface of higher infrared emissivity and the second surface of lower infrared emissivity of the pendent composite sheet can assist in coating both of the first and second layers with higher infrared emissivity materials and lower infrared emissivity materials respectively. It will be appreciated that the term “coated” as used herein, a term used as a result of a “coating” step or the like, will be understood to mean a layer present anywhere within the substrate of variable infrared emissivity. Therefore, it may be envisaged that the term “coated” or “coating” refers to a layer on an external surface of the substrate of variable infrared emissivity, such as the first surface of higher infrared emissivity or the second surface of lower infrared emissivity, for example. It may be equally envisaged that the term “coated” or “coating” refers to a layer within the substrate of variable infrared emissivity. The term “coated” or “coating” will be understood to not be indicative of the location or position of the layer.

### Colouring of Each Pendent Composite Sheet

For some applications of the present invention, it is particularly desirable to be able to control not only the infrared emissivity of the substrate and the pendent composite sheets attached thereto, but also the appearance of the substrate. This can be achieved by modifying the colour of each pendent composite sheet. The inventors have found that each pendent composite sheet can be coloured by using a colouring layer. The colouring layer can be applied to each pendent composite sheet to control the colour of the pendent composite sheet by interference or by displaying the appearance of the colouring layer itself.

In certain embodiments, each pendent composite sheet may comprise a colouring layer. Suitably, the colouring layer has a thickness of 1-50 nm. More suitably, the colouring layer has a thickness of 5-40 nm. Even more suitably, the colouring layer has a thickness of 10-30 nm. Yet even more suitably, the colouring layer has a thickness of 20 nm.

In an embodiment, wherein each pendent composite sheet comprises a colouring layer, the colouring layer comprises silicon. In another embodiment, the colouring layer comprises germanium. In another embodiment, the colouring layer comprises carbon. In yet another embodiment, the colouring layer comprises a chalcogenide. The colouring layer changes the visible appearance when applied to the pendent composite sheet in order to enhance the aesthetics of the substrates, which may be particularly useful in applications such as camouflage. The colouring layer is typically not required on the first surface of higher infrared emissivity as the materials discussed hereinbefore suitable for the first surface of higher infrared emissivity are available in a variety of colours. Colouring the second surface of lower infrared emissivity, however, is challenging as colouring agents and dyes are typically higher infrared emissivity materials. The inventors have found that it is possible to colour surfaces using interference without altering the infrared emissivity. This can be done, for instance, with an ultrathin (˜20 nm) silicon coating on a second surface of lower infrared emissivity such as aluminium, which colours the surface without altering the infrared emissivity. The surface colour can subsequently be adjusted by varying the thickness of the colouring layer, which in this example is a silicon coating.

Alternatively, in embodiments wherein each pendent composite sheet comprises a colouring layer, any suitable coloured material may be used. This method of colouring each pendent composite sheet relies on the appearance of the coloured material being displayed rather than colour generated by interference. Suitably, in an embodiment wherein each pendent composite sheet comprises a colouring layer, the colouring layer may be selected from the group consisting of dyed fabrics or dyed polymeric materials, such as dyed polyvinylchloride tape. However, colouring layers of dyed fabrics or dyed polymeric materials are typically higher emissivity materials. Therefore, if the colouring layer of dyed fabrics or dyed polymeric materials is applied to the second surface of lower infrared emissivity, a transparent conductive layer will need to be applied to the colouring layer.

The second surface of lower infrared emissivity may comprise a transparent conductive layer. Unless specified otherwise, the term transparent is to be understood as being transparent in the visible region. The transparent conductive layer may be applied to a colouring layer such that the transparent conductive layer can display the colouring layer. In an embodiment, the pendent composite sheet may comprise a transparent conductive layer applied to the second surface of lower infrared emissivity. Suitably, the transparent conductive layer applied to the second surface of lower infrared emissivity comprises conductive oxides, which may be transparent in the visible region but exhibit lower infrared emissivity values. Therefore, it may be envisaged that the lower infrared emissivity values of the second surface of lower infrared emissivity may be due solely or in part to the transparent conductive layer. For example, the transparent conductive layer may be coated on a higher infrared emissivity colouring layer, such as a dyed fabric or polymeric material, and display the colour of the dyed fabric or polymeric material. However, given that the transparent conductive layer may itself have a lower emissivity value, the colour of the dyed fabric will be displayed but the surface comprising the dyed fabric and the transparent conductive layer will be of lower infrared emissivity. It will therefore be understood that when a transparent conductive layer is present in the pendent composite sheets of the present invention it may be applied to a material of higher infrared emissivity to form a first surface of higher infrared emissivity and second surface of lower infrared emissivity. In a particularly preferred embodiment, the transparent conductive layer applied to the second surface of lower infrared emissivity comprises indium tin oxide or fluorine tin oxide. More suitably, the transparent conductive layer applied to the second surface of lower infrared emissivity comprises indium tin oxide.

### Infrared Transparent Protecting Layer

In an embodiment, each pendent composite sheet may comprise an infrared transparent protecting layer applied to the second surface of lower infrared emissivity. Given the nature of the materials which are suitable for coating to the second surface of lower infrared emissivity, in some instances, protection may be required to prevent against mechanical wear or the like. It will also be appreciated that it is a requirement that the infrared transparent protecting layer applied to the second surface of lower infrared emissivity does not alter the infrared emissivity (i.e. it is infrared transparent).

In an embodiment wherein each pendent composite sheet comprises an infrared transparent protecting layer applied to the second surface of lower infrared emissivity, the infrared transparent protecting layer comprises polymeric materials. Any suitable polymeric material which is infrared transparent may be applied to the second surface of lower infrared emissivity. Suitably, the polymeric material is selected from the group consisting of polyethylene, polypropylene and Teflon. More suitably, the polymeric material is polyethylene.

In another embodiment wherein each pendent composite sheet comprises an infrared transparent protecting layer applied to the second surface of lower infrared emissivity, the infrared transparent protecting layer comprises diamond-like carbon. In yet another alternative embodiment wherein each pendent composite sheet comprises an infrared transparent protecting layer applied to the second surface of lower infrared emissivity, the infrared transparent protecting layer comprises Parylene. It will be appreciated that any type of Parylene may be used as the infrared transparent protecting layer, including but not limited to Parylene N, Parylene C, Parylene D, Parylene HT, Parylene AF-4 and Parylene F.

### Tuneable Layer

As discussed hereinbefore, the inventors have also surprisingly found that it is possible to use a tuneable layer in order to control the infrared emissivity of a surface of each pendent composite sheet. In an embodiment, each pendent composite sheet may comprise at least one tuneable layer. The tuneability of the infrared emissivity is controlled by the thickness of the tuneable layer which can be coated on a surface of each pendent composite sheet. This is particularly advantageous as it allows for control of the infrared emissivity value of the surfaces of each pendent composite sheet irrespective of the composition of each pendent composite sheet. Therefore, it may be envisaged that the infrared emissivity of a surface of each pendent composite sheet may be due solely or in part to the tuneable layer. Because of this it is preferred that the tuneable layer is coated to an outer surface of each pendant composite sheet (i.e. the tuneable layer is not an internal layer of the pendent composite sheet). In an embodiment, the first surface of higher infrared emissivity comprises at least one tuneable layer. In another embodiment, the second surface of lower infrared emissivity comprises at least one tuneable layer. In yet another embodiment, both the first surface of higher infrared emissivity and the second surface of lower infrared emissivity comprise at least one tuneable layer.

In an embodiment wherein each pendent composite sheet may comprise at least one tuneable layer, the tuneable layer comprises a metal selected from the group consisting of gold, silver, copper, platinum, rhodium, ruthenium, osmium, iridium and palladium. In a particularly suitable embodiment, the tuneable layer comprises platinum.

As discussed hereinbefore, it is possible to control the infrared emissivity of a surface of each pendent composite sheet by applying a tuneable layer. The infrared emissivity of a surface is controlled by the thickness of the tuneable layer. In embodiments wherein the first surface of higher infrared emissivity comprises at least one tuneable layer, the tuneable layer has a thickness of 1-20 nm. Suitably, the tuneable layer has a thickness of 1.5-10 nm. More suitably, the tuneable layer has a thickness of 2-5 nm. Yet more suitably, the tuneable layer has a thickness of 3 nm. In embodiments wherein the second surface of lower infrared emissivity comprises at least one tuneable layer, the tuneable layer has a thickness of 0-0.9 nm. Suitably, the tuneable layer has a thickness of 0-0.5 nm. More suitably, the tuneable layer has a thickness of 0-0.25 nm. Yet more suitably, the tuneable layer has a thickness of 0-0.1 nm.

Therefore, in an embodiment wherein each pendent composite sheet may comprise at least one tuneable layer, the following configuration is possible:
I. a metal as defined hereinbefore as a second surface of lower infrared emissivity;
II. a polymeric layer, such as Parylene, which has a thickness of ¼ of the desired wavelength (typically 2.5 μm); and
III. a tuneable layer coated on the surface of the polymeric layer.

In this embodiment, the tuneable layer applied to the polymeric layer may be, for example, a 3 nm thick platinum coating in order to give a higher infrared emissivity value to this surface.

### Infrared Emissivity Values

As discussed hereinbefore, each pendent composite sheet fixed to the substrates of the present invention comprises a first surface of higher infrared emissivity and a second surface of lower infrared emissivity. It will be understood that the terms higher and lower when used in the context of infrared emissivity values are to be considered relative terms. Indeed, the first surface of higher infrared emissivity is defined as having an infrared emissivity value that is greater than the second surface of lower infrared emissivity. Likewise, the second surface of lower infrared emissivity is defined as having an infrared emissivity value that is less than the first surface of higher infrared emissivity. In this regard, it may be envisaged that the second surface of lower infrared emissivity has an infrared emissivity value that could be considered as a high infrared emissivity value but is in fact still lower than the infrared emissivity value of the first surface of higher infrared emissivity. Similarly, it may be equally envisaged that that the first surface of higher infrared emissivity has an infrared emissivity value that could be considered as a low infrared emissivity value but is in fact still higher than the infrared emissivity value of the second surface of lower infrared emissivity.

In particular preferred embodiments, it is possible to give a numerical infrared emissivity value to the first surface of higher infrared emissivity and the second surface of lower infrared emissivity. It will be appreciated that infrared emissivity values are dimensionless and can range from 0-1, as determined by the ratio of the energy radiated from a material's surface to the energy radiated from a perfect emitter, otherwise known as a blackbody emitter. In a preferred embodiment, the first surface of higher infrared emissivity has an infrared emissivity value of 0.5-1 and the second surface of lower infrared emissivity has an infrared emissivity value of 0-0.49. Suitably, the first surface of higher infrared emissivity has an infrared emissivity value of 0.6-1 and the second surface of lower infrared emissivity has an infrared emissivity value of 0-0.4. More suitably, the first surface of higher infrared emissivity has an infrared emissivity value of and the second surface of lower infrared emissivity has an infrared emissivity value of 0-Even more suitably, the first surface of higher infrared emissivity has an infrared emissivity value of 0.8-1 and the second surface of lower infrared emissivity has an infrared emissivity value of 0-0.2.

### Shape and Configuration of Each Pendent Composite Sheet

In an embodiment, each pendent composite sheet may take the form of any suitable shape or configuration. In a particular preferred embodiment, each pendent composite sheet is a disc. In another embodiment, each pendent composite sheet is a hexagon. In yet another embodiment, each pendent composite sheet is a quadrilateral, such as a square, rectangle, rhombus, diamond or the like. In an embodiment, each pendent composite sheet may be a sequin paillette in the shape of any of the aforementioned shapes. It will be understood that the shape or configuration of each pendent composite sheet is not limited to any of the aforementioned shapes or configurations, which are merely examples, and that any suitable shape or configuration may be used for each pendent composite sheet.

In particularly suitable embodiments, each pendent composite sheet may comprise:
a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
optionally an adhesion layer having a thickness of 1-10 nm and comprises chromium or titanium;
a second surface of lower infrared emissivity, wherein the second surface of lower infrared emissivity is coated with/comprises gold, silver, aluminium, copper, nickel, steel, titanium, chromium, platinum, iron, indium tin oxide, fluorine tin oxide, graphene and/or a dielectric layer of lower infrared emissivity;
optionally a colouring layer having a thickness of 1-50 nm and comprises silicon, germanium, carbon or a chalcogenide; and
optionally an infrared transparent protecting layer comprising polyethylene, polypropylene, Teflon, diamond-like carbon or Parylene.

In particularly suitable embodiments, each pendent composite sheet may comprise:
a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
an adhesion layer having a thickness of 1-10 nm and comprises chromium or titanium;
a second surface of lower infrared emissivity, wherein the second surface of lower infrared emissivity is coated with/comprises gold, silver, aluminium, copper, nickel, steel, titanium, chromium, platinum, iron, indium tin oxide, fluorine tin oxide, graphene and/or a dielectric layer of lower infrared emissivity;
a colouring layer having a thickness of 1-50 nm and comprises silicon, germanium, carbon or a chalcogenide; and
an infrared transparent protecting layer comprising polyethylene, polypropylene, Teflon, diamond-like carbon or Parylene.

In particularly suitable embodiments, each pendent composite sheet may comprise:
a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
an adhesion layer having a thickness of 1-10 nm and comprises chromium or titanium;
a second surface of lower infrared emissivity, wherein the second surface of lower infrared emissivity is coated with/comprises gold, silver, aluminium, copper, nickel, steel, titanium, chromium, platinum, iron, indium tin oxide, fluorine tin oxide, graphene and/or a dielectric layer of lower infrared emissivity;
an infrared transparent protecting layer comprising polyethylene, polypropylene, Teflon, diamond-like carbon or Parylene.

In particularly suitable embodiments, each pendent composite sheet may comprise:
a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
a second surface of lower infrared emissivity, wherein the second surface of lower infrared emissivity is coated with/comprises:
   a colouring layer selected from the group consisting of dyed fabrics or dyed polymeric materials;
   a transparent conductive layer comprising indium tin oxide or fluorine tin oxide; and
optionally an infrared transparent protecting layer comprising polyethylene, polypropylene, Teflon, diamond-like carbon or Parylene.

In particularly suitable embodiments, each pendent composite sheet may comprise:
a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
a second surface of lower infrared emissivity, wherein the second surface of lower infrared emissivity is coated with/comprises:
   a transparent conductive layer comprising indium tin oxide or fluorine tin oxide; and
optionally an infrared transparent protecting layer comprising polyethylene, polypropylene, Teflon, diamond-like carbon or Parylene.

In particularly suitable embodiments, each pendent composite sheet may comprise:
a first surface of higher infrared emissivity, wherein the first surface of higher infrared emissivity is coated with/comprises polyvinylchloride, polyethylene terephthalate, polyethylene, polypropylene, a fabric and/or graphene;
an adhesion layer having a thickness of 1-10 nm and comprises chromium or titanium;
a second surface of lower infrared emissivity, wherein the second surface of lower infrared emissivity is coated with/comprises gold, silver, aluminium, copper, nickel, steel, titanium, chromium, platinum, iron, indium tin oxide, fluorine tin oxide and/or graphene;
optionally a colouring layer having a thickness of 5-40 nm and comprises silicon, germanium, carbon or a chalcogenide; and
optionally an infrared transparent protecting layer comprising polyethylene, polypropylene, Teflon, diamond-like carbon or Parylene.

In particularly suitable embodiments, each pendent composite sheet may comprise:
a first surface of higher infrared emissivity, wherein the first surface of higher infrared emissivity is coated with/comprises polyvinylchloride, polyethylene terephthalate, polyethylene, polypropylene, a fabric and/or graphene;
an adhesion layer having a thickness of 2-8 nm and comprises chromium or titanium;
a second surface of lower infrared emissivity, wherein the second surface of lower infrared emissivity is coated with/comprises gold, aluminium, indium tin oxide, fluorine tin oxide and/or graphene;
optionally a colouring layer having a thickness of 5-40 nm and comprises silicon, germanium, carbon or a chalcogenide; and
optionally an infrared transparent protecting layer comprising polyethylene, polypropylene, Teflon, diamond-like carbon or Parylene.

In particularly suitable embodiments, each pendent composite sheet may comprise:
a first surface of higher infrared emissivity, wherein the first surface of higher infrared emissivity is coated with/comprises polyethylene terephthalate, a fabric and/or graphene;
an adhesion layer having a thickness of 3-7 nm and comprises chromium or titanium;
a second surface of lower infrared emissivity, wherein the second surface of lower infrared emissivity is coated with/comprises gold, aluminium, indium tin oxide and/or graphene;
optionally a colouring layer having a thickness of 10-30 nm and comprises silicon, germanium, carbon or a chalcogenide; and
optionally an infrared transparent protecting layer comprising polyethylene or polypropylene.

In particularly suitable embodiments, each pendent composite sheet may comprise:
a first surface of higher infrared emissivity, wherein the first surface of higher infrared emissivity is coated with/comprises polyethylene terephthalate having a thickness of 1-300 μm;
an adhesion layer having a thickness of 3-7 nm and comprises chromium or titanium;
a second surface of lower infrared emissivity, wherein the second surface of lower infrared emissivity is coated with/comprises gold, aluminium, indium tin oxide and/or graphene;
optionally a colouring layer having a thickness of 10-30 nm and comprises silicon, germanium, carbon or a chalcogenide; and
optionally an infrared transparent protecting layer comprising polyethylene or polypropylene.

In particularly suitable embodiments, each pendent composite sheet may comprise:
a first surface of higher infrared emissivity, wherein the first surface of higher infrared emissivity is coated with/comprises polyethylene terephthalate having a thickness of 20-200 μm;
an adhesion layer having a thickness of 3-7 nm and comprises chromium;
a second surface of lower infrared emissivity, wherein the second surface of lower infrared emissivity is coated with/comprises aluminium;
a colouring layer having a thickness of 10-30 nm and comprises silicon; and
an infrared transparent protecting layer comprising polyethylene.

In particularly suitable embodiments, each pendent composite sheet may comprise:
a first surface of higher infrared emissivity, wherein the first surface of higher infrared emissivity is coated with/comprises a fabric having a thickness of 20-200 μm;
an adhesion layer having a thickness of 3-7 nm and comprises chromium;
a second surface of lower infrared emissivity, wherein the second surface of lower infrared emissivity comprises gold;
a colouring layer having a thickness of 10-30 nm and comprises silicon; and
an infrared transparent protecting layer comprising polyethylene.

In particularly suitable embodiments, each pendent composite sheet may comprise:
a tuneable layer comprising platinum and having a thickness of 1.5-10 nm;
a first surface of higher infrared emissivity, wherein the first surface of higher infrared emissivity is coated with/comprises a polymeric material; and
a second surface of lower infrared emissivity, wherein the second surface of lower infrared emissivity is coated with/comprises a metal;

In particularly suitable embodiments, each pendent composite sheet may comprise:
a first surface of higher infrared emissivity, wherein the first surface of higher infrared emissivity is coated with/comprises a dielectric layer of higher infrared emissivity; and
a second surface of lower infrared emissivity, wherein the second surface of lower infrared emissivity is coated with/comprises a dielectric layer of lower infrared emissivity.

### Methods of Varying the Infrared Emissivity

The substrates of the present invention offer a wealth of applications due to the controllable infrared emissivity provided by the plurality of pendent composite sheets fixed thereto. Each pendent composite sheet comprises a first surface of higher infrared emissivity and a second surface of lower infrared emissivity, meaning that it is possible to control the infrared emissivity of the substrate by moving one or more of the pendent composite sheets.

According to a third aspect of the present invention there is provided a method of varying the infrared emissivity on a surface of a substrate according to the first aspect of the present invention, the method comprising moving one or more pendent composite sheets between a first position in which the first surface of higher infrared emissivity covers a portion of the surface of the substrate and a second position in which the second surface of lower infrared emissivity covers a portion of the surface of the substrate, or vice versa.

It will be understood that each pendent composite sheet may move independently between the first position in which the first surface of higher infrared emissivity covers a portion of the surface of the substrate and the second position in which the second surface of lower infrared emissivity covers a portion of the surface of the substrate. Likewise, it will also be equally understood that each pendent composite sheet may move independently between the second position in which the second surface of lower infrared emissivity covers a portion of the surface of the substrate and the first position in which the first surface of higher infrared emissivity covers a portion of the surface of the substrate.

The phrase “covers a portion” means that either the first surface of higher infrared emissivity or the second surface of lower infrared emissivity resides over a part of the substrate and exposes the opposing surface to the external environment. Therefore, it may be possible for the first surface of higher infrared emissivity to reside over a part of the substrate such that the second surface of lower infrared emissivity is exposed to the external environment. Likewise, it may be equally possible for the second surface of lower infrared emissivity to reside over a part of the substrate such that the first surface of higher infrared emissivity is exposed to the external environment. Of course, it will be understood that the degree of exposure to the external environment will be dependent on how much of the opposing surface resides over the substrate. In this regard, it is possible for either the first surface of higher infrared emissivity or the second surface of lower infrared emissivity to reside over part of the substrate at any angle relative to the substrate surface. As such, the degree of exposure of either the first surface of higher infrared emissivity or the second surface of lower infrared emissivity may be controlled, thereby controlling the infrared emissivity of the substrate.

In an embodiment, each pendent composite sheet is independently positioned in the first position whereby the first surface of higher infrared emissivity covers a portion of the surface of the substrate such that the second surface of lower infrared emissivity is exposed to an external environment relative to the substrate.

In another embodiment each pendent composite sheet is independently positioned in the second position whereby the second surface of lower infrared emissivity covers a portion of the surface of the substrate such that the first surface of higher infrared emissivity is exposed to an external environment relative to the substrate.

In yet another embodiment each pendent composite sheet is independently positioned in between the first and second positions.

The means of fixing each pendent composite sheet to the substrates of the present invention means that it is possible to control the position of each pendent composite sheet, thereby controlling the infrared emissivity of the substrate. In an embodiment, each pendent composite sheet is fixed to the substrate surface such that it can be manually or mechanically flipped between the first and second positions. Manual flipping refers to any form of flipping wherein each pendent composite sheet is controlled by a human. Mechanical flipping refers to any form of flipping wherein each pendent composite sheet is controlled by any type of mechanical device or machine. It may also be possible for each pendent composite sheet to be controlled by other means, such as but not limited to, an electrical voltage, magnets and smart materials which can swell in response to environmental conditions such as, for example, humidity and temperature. Furthermore, it is also appreciated that where a pendent composite sheet overlaps with another pendent composite sheet, the movement of pendent composite sheets may have a direct bearing on the overlapping pendent composite sheet. For example, it is possible for a pendent composite sheet which is moved from the first position in which the first surface of higher infrared emissivity covers a portion of the surface of the substrate to the second position in which the second surface of lower infrared emissivity covers a portion of the surface of the substrate, to make any pendent composite sheets which overlap to also move from the first position in which the first surface of higher infrared emissivity covers a portion of the surface of the substrate to the second position in which the second surface of lower infrared emissivity covers a portion of the surface of the substrate. It will also be appreciated that the pendent composite sheets do not need to overlap with one another, and even if they do, it is not guaranteed that they will have an effect on the overlapping pendent composite sheets. Indeed, it will be understood that the pendent composite sheets may overlap but can be moved independently to one another.

### Applications

As described hereinbefore, the substrates disclosed herein offer a wealth of applications in which controlling the infrared emissivity is functionally important. The substrates of the present invention offer controllability of infrared emissivity meaning that it is possible to thermally regulate objects as well as using the substrates for communication and identification by varying the infrared emissivity. As a consequence of these advantageous properties of the present invention, the substrates are ideally suited for applications in thermal management and identification and communication to infrared sensitive technologies.

According to a fourth aspect of the present invention there is provided a use of a substrate according to the first aspect of the present invention for dynamic thermal management by controlling the infrared emissivity of the surface of a substrate, wherein the use for dynamic thermal management by controlling the infrared emissivity of the surface of a substrate is according to the method of the third aspect of the present invention. Dynamic thermal management refers to enhancing or reducing the heat transfer through infrared radiation depending on the need. The technology can be part of everyday apparels such as, for example, shirts and jackets.

According to a fifth aspect of the present invention there is provided a use of a substrate according to the first aspect of the present invention for camouflage technology infrared communication, wherein the use for camouflage technology infrared communication is according to the method of the third aspect of the present invention. The camouflage technology infrared communication can be exploited by making targets visible and invisible to infrared cameras and can also use the visibility or lack thereof to communicate messages to infrared cameras and any other infrared emission sensitive technologies.

According to a sixth aspect of the present invention there is provided a use of a substrate according to the first aspect of the present invention as a heat regulating protective cover, wherein the use for heat regulating protective covers is according to the method of the third aspect of the present invention. The heat protecting covers, may, for example, be of any size and may be suitable to completely or partially cover an object such as a car, a building or a satellite and thus thermally regulate the object by varying the infrared emissivity of the substrate. This removes the need for externally powered heating or cooling elements.

The following numbered statements 1 to 183 are not claims, but instead serve to define particular aspects and embodiments of the claimed invention:
1. A substrate having a surface of variable infrared emissivity, wherein at least one surface of the substrate comprises a plurality of pendent composite sheets fixed thereto,
   and wherein each pendent composite sheet comprises a first surface of higher infrared emissivity and a second surface of lower infrared emissivity, and
   wherein each pendent composite sheet is independently fixed to the substrate and configured such that each sheet can be moved between a first position in which the first surface of higher infrared emissivity covers a portion of the surface of the substrate and a second position in which the second surface of lower infrared emissivity covers a portion of the surface of the substrate.
2. The substrate of statement 1, wherein the substrate is selected from the group consisting of textiles, non-woven textiles, fabric, polymeric material, a surface of an object or article, and a combination thereof.
3. The substrate of statement 2, wherein the substrate is a textile.
4. The substrate of statement 2, wherein the substrate is a non-woven textile.
5. The substrate of statement 2, wherein the substrate is a polymeric material.
6. The substrate of statement 2, wherein the substrate is a surface of an object.
7. The substrate of statement 2, wherein the substrate is a surface of an article.
8. The substrate of statement 2, wherein the substrate is a fabric.
9. The substrate of statement 8, wherein the fabric is selected from the group consisting of cotton, polyester, nylon and cloth.
10. The substrate of statement 9, wherein the fabric is cotton.
11. The substrate of statement 9, wherein the fabric is polyester.
12. The substrate of statement 9, wherein the fabric is nylon.
13. The substrate of statement 9, wherein the fabric is cloth.
14. The substrate of any preceding statement, wherein each pendent composite sheet is independently fixed to the substrate by a thread, a hook, a linker, a hinge, sewing means or a connecting member.
15. The substrate of statement 14, wherein each pendent composite sheet is independently fixed to the substrate by a thread.
16. The substrate of statement 14, wherein each pendent composite sheet is independently fixed to the substrate by a hook.
17. The substrate of statement 14, wherein each pendent composite sheet is independently fixed to the substrate by a linker.
18. The substrate of statement 14, wherein each pendent composite sheet is independently fixed to the substrate by a hinge.
19. The substrate of statement 14, wherein each pendent composite sheet is independently fixed to the substrate by sewing means.
20. The substrate of statement 14, wherein each pendent composite sheet is independently fixed to the substrate by a connecting member.
21. The substrate of any preceding statement, wherein each pendent composite sheet comprises a first surface of higher infrared emissivity, wherein the first surface of higher infrared emissivity is coated with/comprises at least one material selected from the group consisting of polymeric materials, fabrics, graphene and/or a dielectric layer of higher infrared emissivity.
22. The substrate of statement 21, wherein each pendent composite sheet comprises a first surface of higher infrared emissivity, wherein the first surface of higher infrared emissivity is coated with/comprises a polymeric material.
23. The substrate of statement 22, wherein the polymeric material is selected from the group consisting of polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass and combinations thereof.
24. The substrate of statement 23, wherein the polymeric material is polyvinylchloride.
25. The substrate of statement 23, wherein the polymeric material is polyethylene terephthalate.
26. The substrate of statement 23, wherein the polymeric material is polyethylene.
27. The substrate of statement 23, wherein the polymeric material is polypropylene.
28. The substrate of statement 23, wherein the polymeric material is polystyrene.
29. The substrate of statement 23, wherein the polymeric material is Nylon.
30. The substrate of statement 23, wherein the polymeric material is Teflon.
31. The substrate of statement 23, wherein the polymeric material is a polyurethane.
32. The substrate of statement 23, wherein the polymeric material is polychlorotrifluoroethylene.
33. The substrate of statement 23, wherein the polymeric material is poly(methyl methacrylate).
34. The substrate of statement 23, wherein the polymeric material is polydimethylsiloxane.
35. The substrate of statement 23, wherein the polymeric material is Parylene.
36. The substrate of statement 23, wherein the polymeric material is glass.
37. The substrate of statement 21, wherein each pendent composite sheet comprises a first surface of higher infrared emissivity, wherein the first surface of higher infrared emissivity is coated with/comprises a fabric.
38. The substrate of statement 37, wherein the fabric is selected from a group consisting of cotton, polyester, silk and a combination thereof.
39. The substrate of statement 38, wherein the fabric is cotton.
40. The substrate of statement 38, wherein the fabric is polyester.
41. The substrate of statement 38, wherein the fabric is silk.
42. The substrate of statement 21, wherein the first surface of higher infrared emissivity is coated with/comprises at least one material selected from the group consisting of polymeric materials and/or fabrics, the coating on the first surface of higher infrared emissivity has a thickness of 1-300 μm.
43. The substrate of statement 21, wherein the first surface of higher infrared emissivity is coated with/comprises at least one material selected from the group consisting of polymeric materials and/or fabrics, the coating on the first surface of higher infrared emissivity has a thickness of 20-200 μm.
44. The substrate of statement 21, wherein the first surface of higher infrared emissivity is coated with/comprises at least one material selected from the group consisting of polymeric materials and/or fabrics, the coating on the first surface of higher infrared emissivity has a thickness of 40-100 μm.
45. The substrate of statement 21, wherein the first surface of higher infrared emissivity is coated with/comprises at least one material selected from the group consisting of polymeric materials and/or fabrics, the coating on the first surface of higher infrared emissivity has a thickness of 60-80 μm.
46. The substrate of statement 21, wherein each pendent composite sheet comprises a first surface of higher infrared emissivity, wherein the first surface of higher infrared emissivity is coated with/comprises graphene.
47. The substrate of statement 46, wherein the graphene has a thickness of 1.9-95 nm.
48. The substrate of statement 46, wherein the graphene has a thickness of 3.8-85.5 nm.
49. The substrate of statement 46, wherein the graphene has a thickness of 5.7-76 nm. The substrate of statement 46, wherein the graphene has a thickness of 7.6-66.5 nm.
51. The substrate of statement 46, wherein the graphene has a thickness of 9.5-57 nm.
52. The substrate of statement 46, wherein the graphene has a thickness of 5-250 layers of graphene.
53. The substrate of statement 46, wherein the graphene has a thickness of 10-225 layers of graphene.
54. The substrate of statement 46, wherein the graphene has a thickness of 15-200 layers of graphene.
55. The substrate of statement 46, wherein the graphene has a thickness of 20-175 layers of graphene.
56. The substrate of statement 46, wherein the graphene has a thickness of 25-150 layers of graphene.
57. The substrate of statement 21, wherein each pendent composite sheet comprises a first surface of higher infrared emissivity, wherein the first surface of higher infrared emissivity is coated with/comprises a dielectric layer of higher infrared emissivity.
58. The substrate of statement 57, wherein the dielectric layer comprises at least one metal layer, at least one polymeric material layer and at least one tuneable layer.
59. The substrate of statement 58, wherein the at least one metal layer comprises gold, silver, aluminium, copper, nickel, steel, titanium, chromium, platinum and/or iron.
60. The substrate of statement 58, wherein the at least one polymeric material layer comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene and/or glass.
61. The substrate of statement 58 wherein the at least one tuneable layer has a thickness of 1-20 nm.
62. The substrate of statement 58, wherein the at least one tuneable layer has a thickness of 1.5-10 nm.
63. The substrate of statement 58, wherein the at least one tuneable layer has a thickness of 2-5 nm.
64. The substrate of statement 58, wherein the at least one tuneable layer has a thickness of 3 nm.
65. The substrate of statement 58, wherein the at least one tuneable layer comprises a metal selected from the group consisting of gold, silver, copper, platinum, rhodium, ruthenium, osmium, iridium and/or palladium.
66. The substrate of any preceding statement, wherein each pendent composite sheet comprises a second surface of lower infrared emissivity, wherein the second surface of lower infrared emissivity is coated with/comprises at least one material selected from the group consisting of metals, metal foils, conductive oxides, graphene and/or a dielectric layer of lower infrared emissivity.
67. The substrate of statement 66, wherein each pendent composite sheet comprises a second surface of lower infrared emissivity, wherein the second surface of lower infrared emissivity is coated with/comprises a metal or metal foil.
68. The substrate of statement 67, wherein the metal or metal foil is selected from the group consisting of gold, silver, aluminium, copper, nickel, steel, titanium, chromium, platinum and iron.
69. The substrate of statement 68, wherein the metal or metal foil is gold
70. The substrate of statement 68, wherein the metal or metal foil is silver.
71. The substrate of statement 68, wherein the metal or metal foil is aluminium.
72. The substrate of statement 68, wherein the metal or metal foil is copper.
73. The substrate of statement 68, wherein the metal or metal foil is nickel.
74. The substrate of statement 68, wherein the metal or metal foil is steel.
75. The substrate of statement 68, wherein the metal or metal foil is titanium.
76. The substrate of statement 68, wherein the metal or metal foil is chromium.
77. The substrate of statement 68, wherein the metal or metal foil is platinum.
78. The substrate of statement 68, wherein the metal or metal foil is iron.
79. The substrate of statement 66, wherein each pendent composite sheet comprises a second surface of lower infrared emissivity, wherein the second surface of lower infrared emissivity is coated with/comprises a conductive oxide.
80. The substrate of statement 79, wherein the conductive oxide is indium tin oxide.
81. The substrate of statement 79, wherein the conductive oxide is fluorine tin oxide.
82. The substrate of statement 66, wherein the second surface of lower infrared emissivity is coated with/comprises at least one material selected from the group consisting of metals, metal foils and/or conductive oxides, the coating on the second surface of lower infrared emissivity has a thickness of 1-20000 nm
83. The substrate of statement 66, wherein the second surface of lower infrared emissivity is coated with/comprises at least one material selected from the group consisting of metals, metal foils and/or conductive oxides, the coating on the second surface of lower infrared emissivity has a thickness of 10-10000 nm.
84. The substrate of statement 66, wherein the second surface of lower infrared emissivity is coated with/comprises at least one material selected from the group consisting of metals, metal foils and/or conductive oxides, the coating on the second surface of lower infrared emissivity has a thickness of 100-9000 nm.
85. The substrate of statement 66, wherein the second surface of lower infrared emissivity is coated with/comprises at least one material selected from the group consisting of metals, metal foils and/or conductive oxides, the coating on the second surface of lower infrared emissivity has a thickness of 500-7000 nm.
86. The substrate of statement 66, wherein the second surface of lower infrared emissivity is coated with/comprises at least one material selected from the group consisting of metals, metal foils and/or conductive oxides, the coating on the second surface of lower infrared emissivity has a thickness of 1000-5000 nm.
87. The substrate of statement 66, wherein each pendent composite sheet comprises a second surface of lower infrared emissivity, wherein the second surface of lower infrared emissivity is coated with/comprises graphene.
88. The substrate of statement 87, wherein the graphene has a thickness of 28.5-570 nm.
89. The substrate of statement 87, wherein the graphene has a thickness of 38-475 nm.
90. The substrate of statement 87, wherein the graphene has a thickness of 47.5-380 nm.
91. The substrate of statement 87, wherein the graphene has a thickness of 57-285 nm.
92. The substrate of statement 87, wherein the graphene has a thickness of 76-190 nm.
93. The substrate of statement 87, wherein the graphene has a thickness of 75-1500 layers of graphene.
94. The substrate of statement 87, wherein the graphene has a thickness of 100-1250 layers of graphene.
95. The substrate of statement 87, wherein the graphene has a thickness of 125-1000 layers of graphene.
96. The substrate of statement 87, wherein the graphene has a thickness of 150-750 layers of graphene.
97. The substrate of statement 87, wherein the graphene has a thickness of 200-500 layers of graphene.
98. The substrate of statement 66, wherein each pendent composite sheet comprises a second surface of lower infrared emissivity, wherein the second surface of lower infrared emissivity is coated with/comprises a dielectric layer of lower infrared emissivity.
99. The substrate of statement 98, wherein the dielectric layer comprises at least one metal layer, at least one polymeric material layer and at least one tuneable layer.
100. The substrate of statement 99, wherein the at least one metal layer comprises gold, silver, aluminium, copper, nickel, steel, titanium, chromium, platinum and/or iron.
101. The substrate of statement 99, wherein the at least one polymeric material layer comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene and/or glass.
102. The substrate of statement 99, wherein the at least one tuneable layer has a thickness of 0-0.9 nm.
103. The substrate of statement 99, wherein the at least one tuneable layer has a thickness of 0-0.5 nm.
104. The substrate of statement 99, wherein the at least one tuneable layer has a thickness of 0-0.25 nm.
105. The substrate of statement 99, wherein the at least one tuneable layer has a thickness of 0-0.1 nm.
106. The substrate of statement 99, wherein the at least one tuneable layer comprises a metal selected from the group consisting of gold, silver, copper, platinum, rhodium, ruthenium, osmium, iridium and/or palladium.
107. The substrate of any preceding statement, wherein each pendent composite sheet comprises an adhesion layer positioned between the layers forming the first surface of higher infrared emissivity and the second surface of lower infrared emissivity of the pendent composite sheet.
108. The substrate of statement 107, wherein the adhesion layer has a thickness of 1-10 nm.
109. The substrate of statement 107, wherein the adhesion layer has a thickness of 2-8 nm.
110. The substrate of statement 107, wherein the adhesion layer has a thickness of 3-7 nm.
111. The substrate of statement 107, wherein the adhesion layer has a thickness of 5 nm.
112. The substrate of statement 107, wherein the adhesion layer comprises chromium.
113. The substrate of statement 107, wherein the adhesion layer comprises titanium.
114. The substrate of any preceding statement, wherein each pendent composite sheet comprises a colouring layer.
115. The substrate of statement 114, wherein the colouring layer has a thickness of 1-50 nm.
116. The substrate of statement 114, wherein the colouring layer has a thickness of 5-40 nm.
117. The substrate of statement 114, wherein the colouring layer has a thickness of 10-30 nm.
118. The substrate of statement 114, wherein the colouring layer has a thickness of 20 nm.
119. The substrate of statement 114, wherein the colouring layer comprises silicon.
120. The substrate of statement 114, wherein the colouring layer comprises germanium.
121. The substrate of statement 114, wherein the colouring layer comprises carbon.
122. The substrate of statement 114, wherein the colouring layer comprises a chalcogenide.
123. The substrate of statement 114, wherein the colouring layer is a dyed fabric.
124. The substrate of statement 114, wherein the colouring layer is a dyed polymeric material.
125. The substrate of any preceding statement, wherein each pendent composite sheet comprises a transparent conductive layer applied to the second surface of lower infrared emissivity.
126. The substrate of statement 125, wherein the transparent conductive layer applied to the second surface of lower infrared emissivity comprises conductive oxides.
127. The substrate of statement 125, wherein the conductive oxide comprises indium tin oxide.
128. The substrate of statement 125, wherein the conductive oxide comprises fluorine tin oxide.
129. The substrate of any preceding statement, wherein each pendent composite sheet comprises an infrared transparent protecting layer applied to the second surface of lower infrared emissivity.
130. The substrate of statement 129, wherein the infrared transparent protecting layer applied to the second surface of lower infrared emissivity comprises polymeric materials.
131. The substrate of statement 130, wherein the polymeric material is selected from the group consisting of polyethylene, polypropylene or Teflon.
132. The substrate of statement 131, wherein the polymeric material is polyethylene.
133. The substrate of statement 131, wherein the polymeric material is polypropylene.
134. The substrate of statement 131, wherein the polymeric material is Teflon.
135. The substrate of statement 130, wherein the infrared transparent protecting layer applied to the second surface of lower infrared emissivity comprises diamond-like carbon.
136. The substrate of statement 130, wherein the infrared transparent protecting layer applied to the second surface of lower infrared emissivity comprises Parylene.
137. The substrate of any preceding statement, wherein each pendent composite sheet comprises at least one tuneable layer.
138. The substrate of statement 137, wherein the first surface of higher infrared emissivity comprises at least one tuneable layer.
139. The substrate of statement 137, wherein the second surface of lower infrared emissivity comprises at least one tuneable layer.
140. The substrate of statement 137, wherein both the first surface of higher infrared emissivity and the second surface of lower infrared emissivity comprise at least one tuneable layer.
141. The substrate of statement 137, wherein the at least one tuneable layer comprises a metal selected from the group consisting of gold, silver, copper, platinum, rhodium, ruthenium, osmium, iridium and palladium.
142. The substrate of statement 137, wherein the first surface of higher infrared emissivity comprises a tuneable layer, the tuneable layer has a thickness of 1-20 nm.
143. The substrate of statement 137, wherein the first surface of higher infrared emissivity comprises a tuneable layer, the tuneable layer has a thickness of 1.5-10 nm.
144. The substrate of statement 137, wherein the first surface of higher infrared emissivity comprises a tuneable layer, the tuneable layer has a thickness of 2-5 nm.
145. The substrate of statement 137, wherein the first surface of higher infrared emissivity comprises a tuneable layer, the tuneable layer has a thickness of 3 nm.
146. The substrate of statement 137, wherein the second surface of lower infrared emissivity comprises a tuneable layer, the tuneable layer has a thickness of 0-0.9 nm.
147. The substrate of statement 137, wherein the second surface of lower infrared emissivity comprises a tuneable layer, the tuneable layer has a thickness of 0-0.5 nm.
148. The substrate of statement 137, wherein the second surface of lower infrared emissivity comprises a tuneable layer, the tuneable layer has a thickness of 0-0.25 nm.
149. The substrate of statement 137, wherein the second surface of lower infrared emissivity comprises a tuneable layer, the tuneable layer has a thickness of 0-0.1 nm.
150. The substrate of any preceding statement, wherein the first surface of higher infrared emissivity has an infrared emissivity value of 0.5-1 and the second surface of lower infrared emissivity has an infrared emissivity value of 0-0.49.
151. The substrate of any preceding statement, wherein the first surface of higher infrared emissivity has an infrared emissivity value of 0.6-1 and the second surface of lower infrared emissivity has an infrared emissivity value of 0-0.4.
152. The substrate of any preceding statement, wherein the first surface of higher infrared emissivity has an infrared emissivity value of 0.7-1 and the second surface of lower infrared emissivity has an infrared emissivity value of 0-0.3.
153. The substrate of any preceding statement, wherein the first surface of higher infrared emissivity has an infrared emissivity value of 0.8-1 and the second surface of lower infrared emissivity has an infrared emissivity value of 0-0.2.
154. The substrate of any preceding statement, wherein each pendent composite sheet is a disc.
155. The substrate of any preceding statement, wherein each pendent composite sheet is hexagon.
156. The substrate of any preceding statement, wherein each pendent composite sheet is a quadrilateral.
157. The substrate of any preceding statement, wherein each pendent composite sheet is a square.
158. The substrate of any preceding statement, wherein each pendent composite sheet is a rectangle.
159. The substrate of any preceding statement, wherein each pendent composite sheet is a rhombus.
160. The substrate of any preceding statement, wherein each pendent composite sheet is a diamond.
161. The substrate of any preceding statement, wherein each pendent composite sheet is a sequin paillette.
162. The substrate of any preceding statement, wherein each pendent composite sheet comprises:
   a) a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
   b) optionally an adhesion layer having a thickness of 1-10 nm and comprises chromium or titanium;
   c) a second surface of lower infrared emissivity, wherein the second surface of lower infrared emissivity is coated with/comprises gold, silver, aluminium, copper, nickel, steel, titanium, chromium, platinum, iron, indium tin oxide, fluorine tin oxide, graphene and/or a dielectric layer of lower infrared emissivity;
   d) optionally a colouring layer having a thickness of 1-50 nm and comprises silicon, germanium, carbon or a chalcogenide; and
   e) optionally an infrared transparent protecting layer comprising polyethylene, polypropylene, Teflon, diamond-like carbon or Parylene.
163. The substrate of any preceding statement, wherein each pendent composite sheet comprises:
   a) a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
   b) an adhesion layer having a thickness of 1-10 nm and comprises chromium or titanium;
   c) a second surface of lower infrared emissivity, wherein the second surface of lower infrared emissivity is coated with/comprises gold, silver, aluminium, copper, nickel, steel, titanium, chromium, platinum, iron, indium tin oxide, fluorine tin oxide, graphene and/or a dielectric layer of lower infrared emissivity;
   d) a colouring layer having a thickness of 1-50 nm and comprises silicon, germanium, carbon or a chalcogenide; and
   e) an infrared transparent protecting layer comprising polyethylene, polypropylene, Teflon, diamond-like carbon or Parylene.
164. The substrate of any preceding statement, wherein each pendent composite sheet comprises:
   a) a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
   b) an adhesion layer having a thickness of 1-10 nm and comprises chromium or titanium;
   c) a second surface of lower infrared emissivity, wherein the second surface of lower infrared emissivity is coated with/comprises gold, silver, aluminium, copper, nickel, steel, titanium, chromium, platinum, iron, indium tin oxide, fluorine tin oxide, graphene and/or a dielectric layer of lower infrared emissivity;
   d) an infrared transparent protecting layer comprising polyethylene, polypropylene, Teflon, diamond-like carbon or Parylene.
165. The substrate of any preceding statement, wherein each pendent composite sheet comprises:
   a) a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
   b) a second surface of lower infrared emissivity, wherein the second surface of lower infrared emissivity is coated with/comprises:
      i. a colouring layer selected from the group consisting of dyed fabrics or dyed polymeric materials;
      ii. a transparent conductive layer comprising indium tin oxide or fluorine tin oxide; and
   c) optionally an infrared transparent protecting layer comprising polyethylene, polypropylene, Teflon, diamond-like carbon or Parylene.
166. The substrate of any preceding statement, wherein each pendent composite sheet comprises:
   a) a first surface of higher infrared emissivity, wherein the first surface of higher infrared emissivity is coated with/comprises polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass, or a combination thereof, a fabric, graphene and/or a dielectric layer of higher infrared emissivity;
   b) a second surface of lower infrared emissivity, wherein the second surface of lower infrared emissivity is coated with/comprises:
      i. a transparent conductive layer comprising indium tin oxide or fluorine tin oxide; and
   c) optionally an infrared transparent protecting layer comprising polyethylene, polypropylene, Teflon, diamond-like carbon or Parylene.
167. The substrate of any preceding statement, wherein each pendent composite sheet comprises:
   a) a first surface of higher infrared emissivity, wherein the first surface of higher infrared emissivity is coated with/comprises polyvinylchloride, polyethylene terephthalate, polyethylene, polypropylene, a fabric and/or graphene;
   b) an adhesion layer having a thickness of 1-10 nm and comprises chromium or titanium;
   c) a second surface of lower infrared emissivity, wherein the second surface of lower infrared emissivity is coated with/comprises gold, silver, aluminium, copper, nickel, steel, titanium, chromium, platinum, iron, indium tin oxide, fluorine tin oxide and/or graphene;
   d) optionally a colouring layer having a thickness of 5-40 nm and comprises silicon, germanium, carbon or a chalcogenide; and
   e) optionally an infrared transparent protecting layer comprising polyethylene, polypropylene, Teflon, diamond-like carbon or Parylene.
168. The substrate of any preceding statement, wherein each pendent composite sheet comprises:
   a) a first surface of higher infrared emissivity, wherein the first surface of higher infrared emissivity is coated with/comprises polyvinylchloride, polyethylene terephthalate, polyethylene, polypropylene, a fabric and/or graphene;
   b) an adhesion layer having a thickness of 2-8 nm and comprises chromium or titanium;
   c) a second surface of lower infrared emissivity, wherein the second surface of lower infrared emissivity is coated with/comprises gold, aluminium, indium tin oxide, fluorine tin oxide and/or graphene;
   d) optionally a colouring layer having a thickness of 5-40 nm and comprises silicon, germanium, carbon or a chalcogenide; and
   e) optionally an infrared transparent protecting layer comprising polyethylene, polypropylene, Teflon, diamond-like carbon or Parylene.
169. The substrate of any preceding statement, wherein each pendent composite sheet comprises:
   a) a first surface of higher infrared emissivity, wherein the first surface of higher infrared emissivity is coated with/comprises polyethylene terephthalate, a fabric and/or graphene;
   b) an adhesion layer having a thickness of 3-7 nm and comprises chromium or titanium;
   c) a second surface of lower infrared emissivity, wherein the second surface of lower infrared emissivity is coated with/comprises gold, aluminium, indium tin oxide and/or graphene;
   d) optionally a colouring layer having a thickness of 10-30 nm and comprises silicon, germanium, carbon or a chalcogenide; and
   e) optionally an infrared transparent protecting layer comprising polyethylene or polypropylene.
170. The substrate of any preceding statement, wherein each pendent composite sheet comprises:
   a) a first surface of higher infrared emissivity, wherein the first surface of higher infrared emissivity is coated with/comprises polyethylene terephthalate having a thickness of 1-300 μm;
   b) an adhesion layer having a thickness of 3-7 nm and comprises chromium or titanium;
   c) a second surface of lower infrared emissivity, wherein the second surface of lower infrared emissivity is coated with/comprises gold, aluminium, indium tin oxide and/or graphene;
   d) optionally a colouring layer having a thickness of 10-30 nm and comprises silicon, germanium, carbon or a chalcogenide; and
   e) optionally an infrared transparent protecting layer comprising polyethylene or polypropylene.
171. The substrate of any preceding statement, wherein each pendent composite sheet comprises:
   a) a first surface of higher infrared emissivity, wherein the first surface of higher infrared emissivity is coated with/comprises polyethylene terephthalate having a thickness of 20-200 μm;
   b) an adhesion layer having a thickness of 3-7 nm and comprises chromium;
   c) a second surface of lower infrared emissivity, wherein the second surface of lower infrared emissivity is coated with/comprises aluminium;
   d) a colouring layer having a thickness of 10-30 nm and comprises silicon; and
   e) an infrared transparent protecting layer comprising polyethylene.
172. The substrate of any preceding statement, wherein each pendent composite sheet comprises:
   a) a first surface of higher infrared emissivity, wherein the first surface of higher infrared emissivity is coated with/comprises a fabric having a thickness of 20-200 μm;
   b) an adhesion layer having a thickness of 3-7 nm and comprises chromium;
   c) a second surface of lower infrared emissivity, wherein the second surface of lower infrared emissivity is coated with/comprises gold;
   d) a colouring layer having a thickness of 10-30 nm and comprises silicon; and
   e) an infrared transparent protecting layer comprising polyethylene.
173. The substrate of any preceding statement, wherein each pendent composite sheet comprises:
   a) a tuneable layer comprising platinum and having a thickness of 1.5-10 nm;
   b) a first surface of higher infrared emissivity, wherein the first surface of higher infrared emissivity is coated with/comprises a polymeric material; and
   c) a second surface of lower infrared emissivity, wherein the second surface of lower infrared emissivity is coated with/comprises a metal.
174. The substrate of any preceding statement, wherein each pendent composite sheet comprises:
   a) a first surface of higher infrared emissivity, wherein the first surface of higher infrared emissivity is coated with/comprises a dielectric layer of higher infrared emissivity; and
   b) a second surface of lower infrared emissivity, wherein the second surface of lower infrared emissivity is coated with/comprises a dielectric layer of lower infrared emissivity.
175. An object or article having a surface coated with a substrate having a surface of variable infrared emissivity disclosed in any one of statements 1-174.
176. A method of varying the infrared emissivity on a surface of a substrate as disclosed in any one of statements 1-174, the method comprising moving one or more pendent composite sheets between a first position in which the first surface of higher infrared emissivity covers a portion of the surface of the substrate and a second position in which the second surface of lower infrared emissivity covers a portion of the surface of the substrate, or vice versa.
177. The method of statement 176, wherein each pendent composite sheet is fixed to the substrate surface such that it can be manually or mechanically flipped between the first and second positions.
178. The method of statement 176, wherein each pendent composite sheet is independently positioned in the first position whereby the first surface of higher infrared emissivity covers a portion of the surface of the substrate such that the second surface of lower infrared emissivity is exposed to an external environment relative to the substrate as disclosed in any one of statements 1-174.
179. The method of statement 176, wherein each pendent composite sheet is independently positioned in the second position whereby the second surface of lower infrared emissivity covers a portion of the surface of the substrate such that the first surface of higher infrared emissivity is exposed to an external environment relative to the substrate as disclosed in any one of statements 1-174.
180. The method of statement 176, wherein each pendent composite sheet is independently positioned between the first and second positions.
181. Use of a substrate of any one of statements 1-174 for dynamic thermal management by controlling the infrared emissivity of the surface of a substrate, wherein the use for dynamic thermal management by controlling the infrared emissivity of the surface of a substrate is according to the method of any one of statements 176-180.
182. Use of a substrate of any one of statements 1-174 for camouflage technology infrared communication, wherein the use for camouflage technology infrared communication is according to the method of any one of statements 176-180.
183. Use of a substrate of any one of statements 1-174 as a heat regulating protective cover, wherein the use for heat regulating protective covers is according to the method of any one of statements 176-180.

### EXAMPLES

One or more examples of the invention will now be described, for the purpose of illustration only, with reference to the accompanying figures, in which:

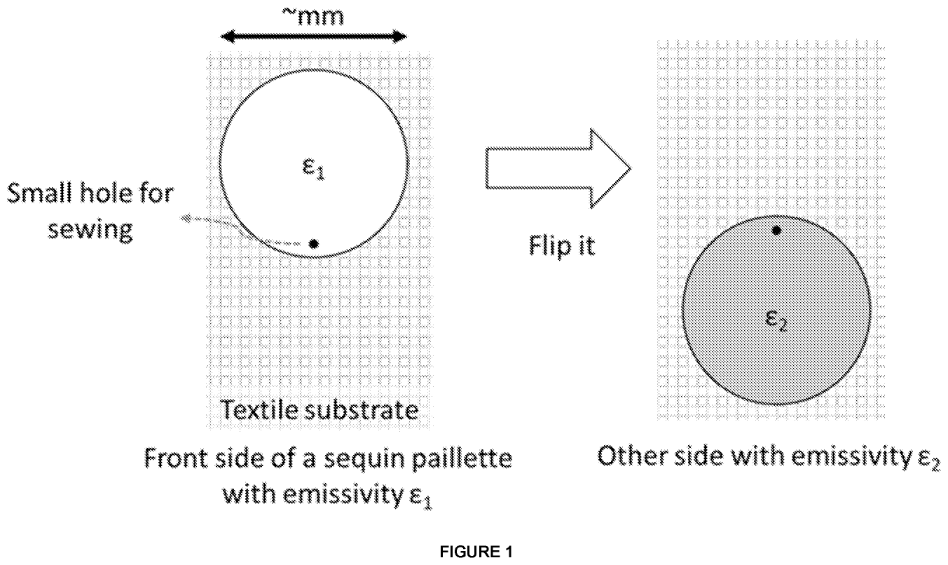

FIG. 1 shows a single pendent composite sheet showing a first side with a first infrared emissivity and a second side with a second infrared emissivity.

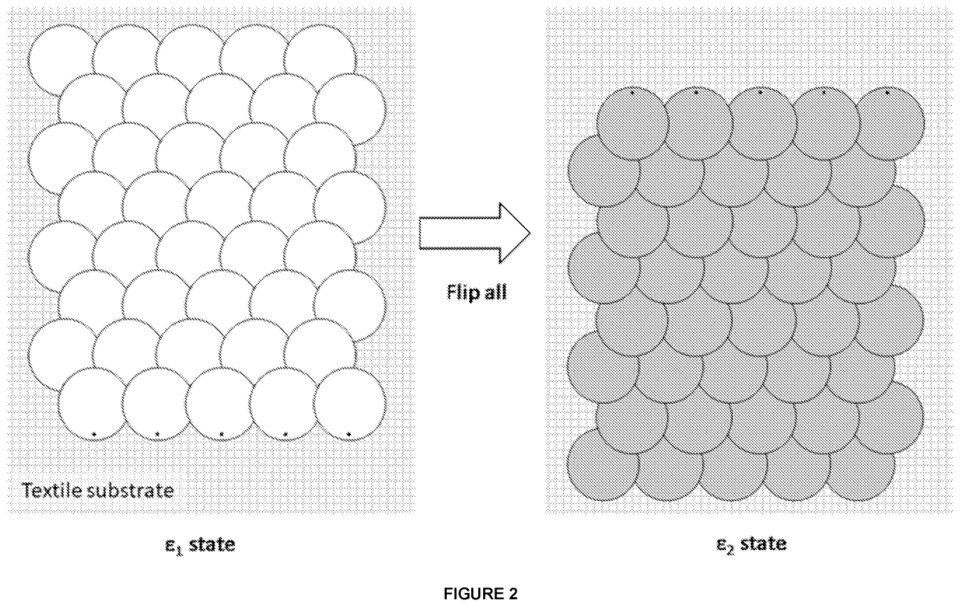

FIG. 2 shows a plurality of pendent composite sheets moving from a first side with a first infrared emissivity to a second side with a second infrared emissivity.

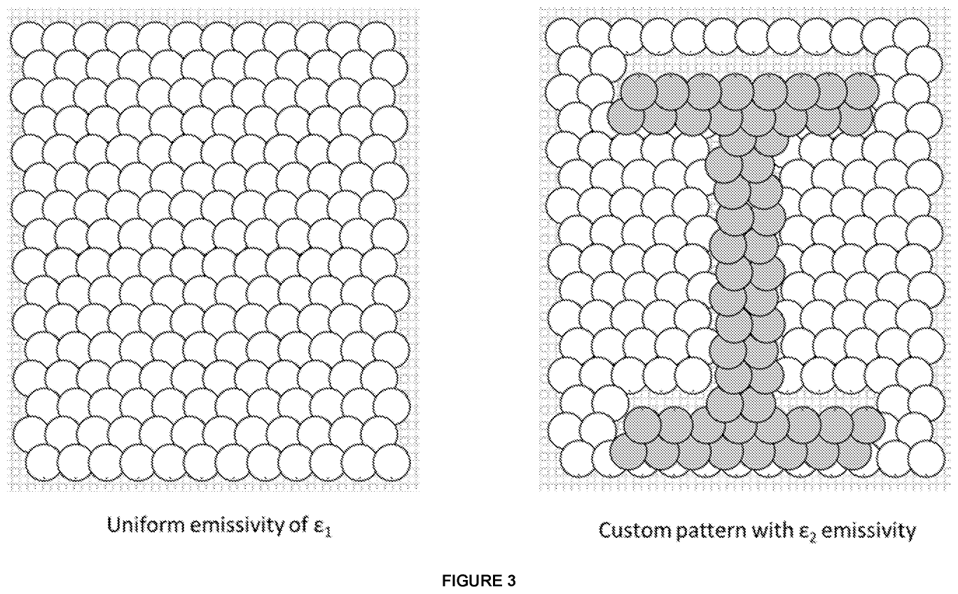

FIG. 3 shows a plurality of pendent composite sheets wherein some of the pendent composite sheets are moved from a first side with a first infrared emissivity to a second side with a second infrared emissivity to display a custom infrared pattern.

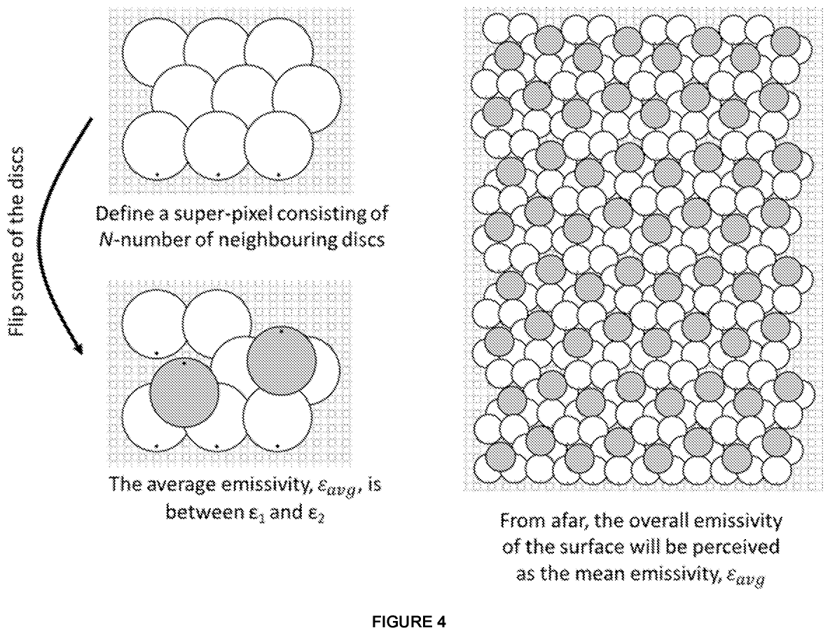

FIG. 4 shows a plurality of pendent composite sheets wherein some of the pendent composite sheets are moved from a first side with a first infrared emissivity to a second side with a second infrared emissivity to modify the average infrared emissivity of the substrate to an arbitrary value.

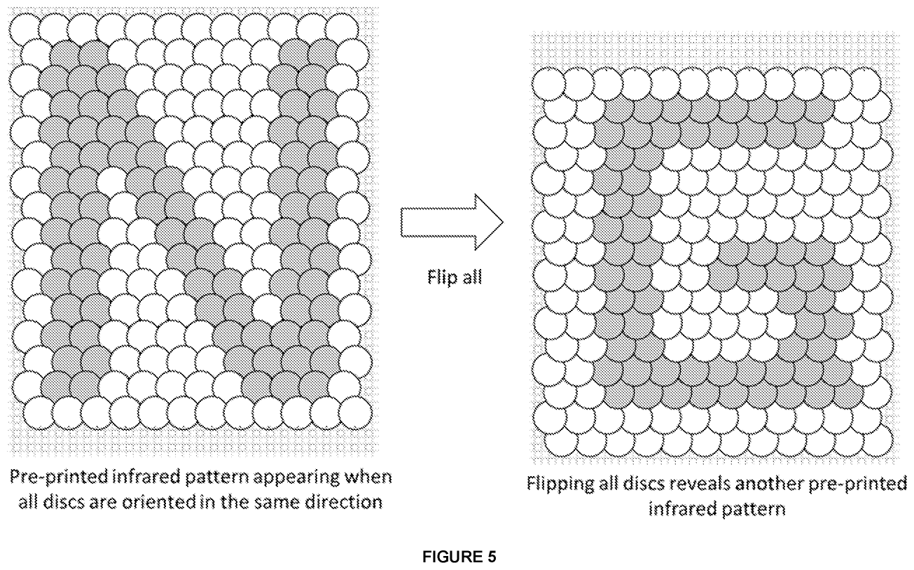

FIG. 5 shows a plurality of pendent composite sheets, some of which are pre-printed in order to display a first custom infrared pattern, wherein all of the pendent composite sheets are moved from a first side with a first infrared emissivity to a second side with a second infrared emissivity such that a second custom infrared pattern is shown.

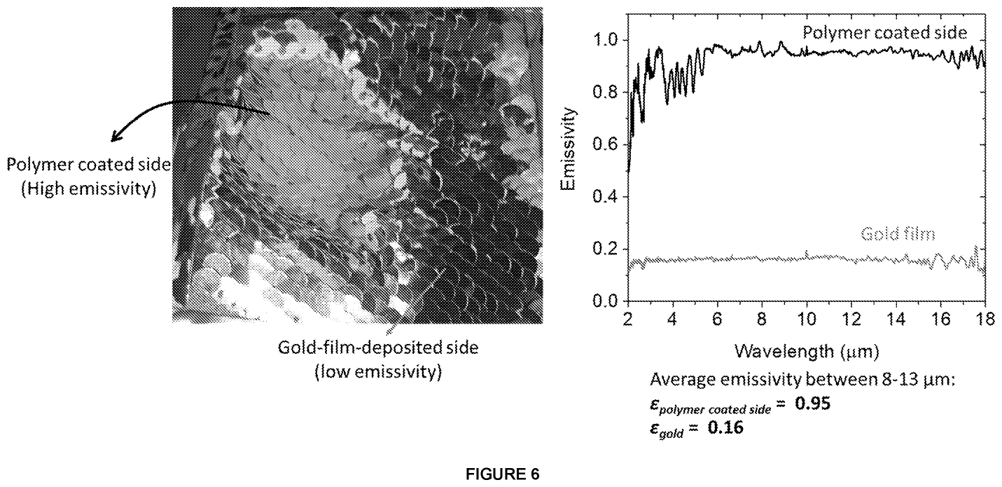

FIG. 6 shows a photograph of a plurality of pendent composite sheets fixed to a substrate, wherein some of the pendent composite sheets display a first surface of higher infrared emissivity and some pendent composite sheets display a second surface of lower infrared emissivity. Also shown is the corresponding infrared emissivity spectrum of said plurality of pendent composite sheets fixed to a substrate.

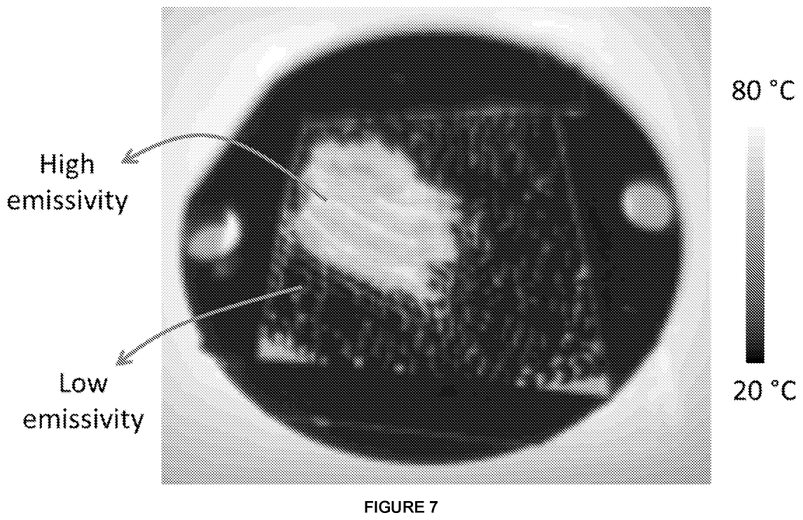

FIG. 7 shows a thermal image of the plurality of pendent composite sheets fixed to a substrate shown in FIG. 6 at ˜78° C., showing the higher and lower infrared emissivity sides of the pendent composite sheets corresponding to apparent temperatures of 70° C. and 26° C. respectively.

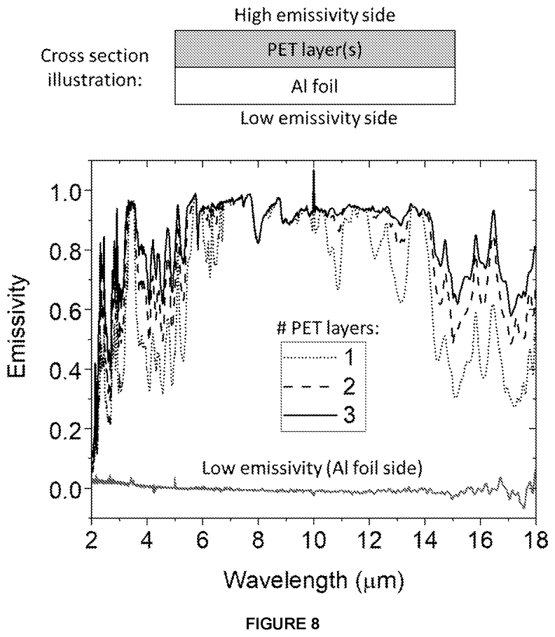

FIG. 8 shows a cross-sectional view of a pendent composite sheet with a polyethylene terephthalate layer on aluminium foil. The infrared emissivity spectrum (also present) shows how increasing the number of polyethylene terephthalate layers enhances the infrared emissivity level of the first surface of higher infrared emissivity.

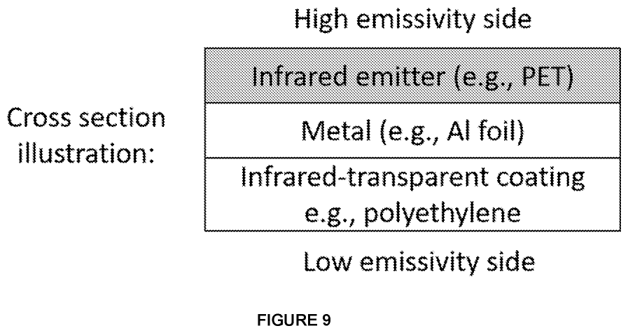

FIG. 9 shows a cross-sectional view of a pendent composite sheet with an additional infrared transparent coating on the second surface of lower infrared emissivity to protect against mechanical wear.

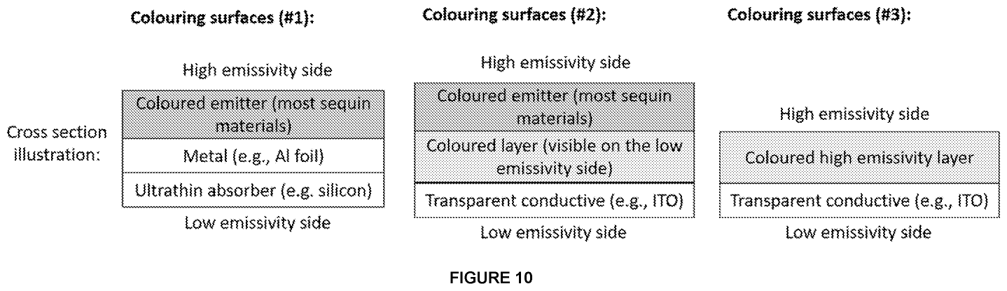

FIG. 10 shows cross-sectional views of three different pendent composite sheets and how they may be coloured by alternative means.

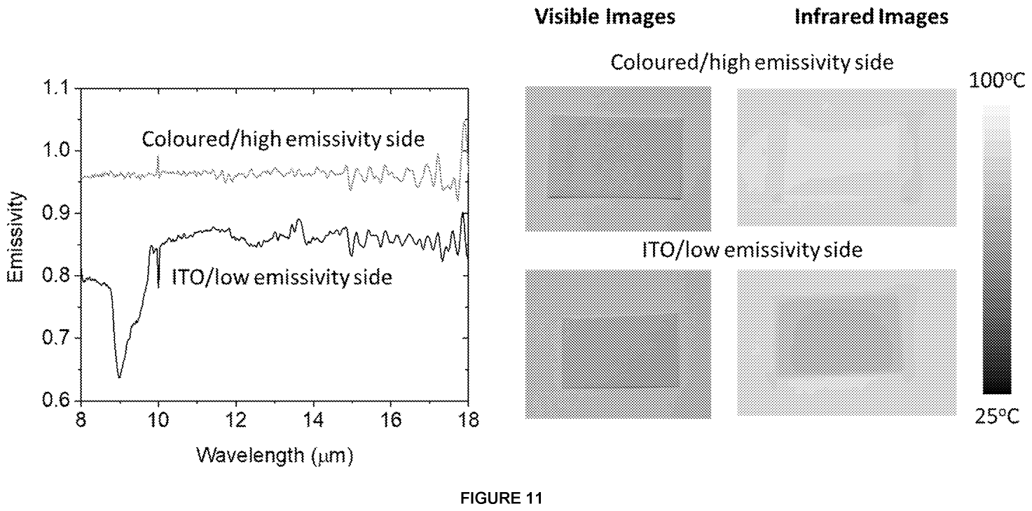

FIG. 11 shows the experimental demonstration of colouring method #3 shown in FIG. 10, including the infrared emissivity spectrum as well as visible and infrared images of an indium tin oxide coating on polyethylene terephthalate.

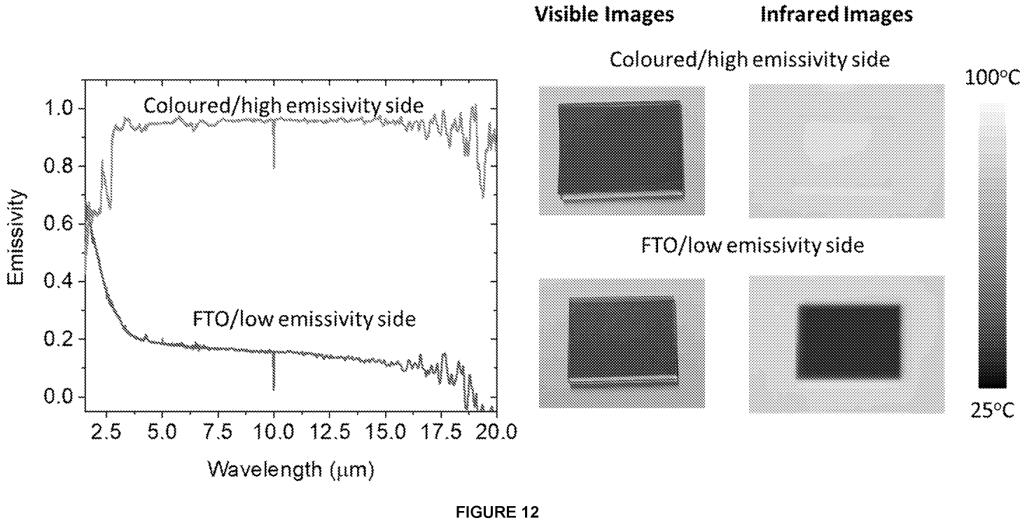

FIG. 12 shows a different experimental demonstration of colouring method #3 shown in FIG. 10, including the infrared emissivity spectrum as well as visible and infrared images of a fluorine tin oxide coating on a pendent composite sheet comprising glass.

FIG. 13 shows a method of adjusting the infrared emissivity levels on either the first surface of higher infrared emissivity or the second surface of lower infrared emissivity using an infrared tuneable layer.

### Materials and Characterisation

Infrared emissivity spectra were measured using a Perkin Elmer Spectrum 100 FTIR spectrometer equipped with a Mid-IR integrating sphere (PIKE Mid-IR IntegratIR) and a wide band liquid-nitrogen-cooled mercury-cadmium-telluride detector. The infrared images of the samples were recorded with a FLIR T660 thermal camera.

The Aluminium foil used in this work was commercially available kitchen aluminium foil and the polyethylene terephthalate films were commercially available 75 μm thick lamination films.

### Modes of Operation

Four different modes of operation are proposed for the present invention and centre around the idea of varying the infrared emissivity of a plurality of pendent composite sheets. All of the modes of operation follow the general concept shown in FIG. 1 whereby the single pendent composite sheet is moved from a first surface of a first infrared emissivity (denoted ci) to a second surface of second infrared emissivity (denoted £ 2). For example, the single pendent composite sheet may be moved between a first position in which the first surface of higher infrared emissivity covers a portion of the surface of the substrate and a second position in which the second surface of lower infrared emissivity covers a portion of the surface of the substrate. This concept is applied to each individual pendent composite sheet in the four modes of operation.

The first mode of operation is shown in FIG. 2 and involves all of the pendent composite sheets moving from a first surface of a first infrared emissivity (ε₁) to a second surface of a second infrared emissivity (ε₂), thereby switching between two distinct infrared emissivity states. It may be that all of the pendent composite sheets move from a first position in which the first surface of higher infrared emissivity covers a portion of the surface of the substrate to a second position in which the second surface of lower infrared emissivity covers a portion of the surface of the substrate. Alternatively, it may be that all of the pendent composite sheets move from a second position in which the second surface of lower infrared emissivity covers a portion of the surface of the substrate to a first position in which the first surface of higher infrared emissivity covers a portion of the surface of the substrate. This mode of operation is particularly useful for dynamic thermal management. Furthermore, heat loss through infrared radiation can be enhanced or reduced by switching between higher or lower infrared emissivity states respectively following this mode of operation.

The second mode of operation is shown in FIG. 3 and involves creating a pattern with contrasting infrared emissivity by only moving certain pendent composite sheets. Since all of the pendent composite sheets are independent, it is possible to select certain pendent composite sheets in order to move them and create a desired infrared pattern. This is an appealing function and particularly advantageous for infrared communication and identification in friend or foe applications used by defence and security services.

The third mode of operation is shown in FIG. 4 and involves moving certain pendent composite sheets in order to change the overall infrared emissivity of the substrate to any desired infrared emissivity value. This is a useful function that can easily be integrated into dynamic thermal camouflage applications in which the infrared emissivity of a surface is expected to follow that of a varying background. In this configuration the average infrared emissivity changes between two distinct levels (ci and £ 2) and exhibits linear dependence on the ratio of the pendent composite sheets which have been moved.

The fourth mode of operation is shown in FIG. 5 and involves changing the aesthetics of certain pendent composite sheets prior to any movement of said pendent composite sheets. As will be seen in FIG. 5, the pre-printed infrared pattern is modified to a different infrared pattern when all of the pendent composite sheets are moved from a first surface of a first infrared emissivity to a second surface of second infrared emissivity. This function can be particularly useful for infrared communication and friend or foe identification as well as switching between thermal camouflage patterns.

### Infrared Studies

The initial approach in investigating the substrates of the present invention was to use a commercial fabric consisting of a plurality of pendent sheets and manipulate its infrared emissivity values as desired. Infrared measurements of the sample showed that the pendent sheets exhibit high infrared emissivity on both sides. By depositing a 5 nm thick chromium layer as an adhesion layer and a 45 nm layer of gold on one surface of the pendent sheet (now termed a pendent composite sheet), the infrared emissivity of that surface was lowered. The deposition was done by thermal evaporation. This is shown in FIG. 6 which displays a photograph of the commercial sequin fabric with a number of the pendent sheets covered with a thin layer of gold and an infrared spectrum generated after measuring the infrared emissivity of the sample. The average infrared emissivity value for the wavelength range of 8-13 μm (long-wavelength infrared regime) was calculated as 0.95 for the polymer coated surface and 0.16 for the gold coated surface of the sample. It is possible for the fabric to switch between these two infrared emissivity values by moving all of the pendent sheets from a first surface to a second surface. FIG. 7 show a thermal image of the sample as discussed above and in FIG. 6. Higher and lower infrared emissivity sides appear in very distinct temperatures despite the sample remaining at the same constant temperature of ˜78° C. This reaffirms the suitability of this technology in the applications set out hereinbefore, in particular the identification and communication applications suitable in the defence sector.

The method of depositing materials onto pendent sheets to manipulate infrared emissivity can typically yield incomplete coverage since some of the pendent sheets overlap with one another. This can be circumvented by coating each pendent composite sheet individually. If, for instance, the pendent sheets are not coated individually but rather in bulk, the incomplete coverage on some of the pendent sheets leads to uncovered areas being exposed once the pendent sheets are moved from a first surface of a first infrared emissivity to a second surface of second infrared emissivity, adversely affecting the lower infrared emissivity state (since the higher infrared emissivity surface was not further coated in the sample). As mentioned, this can be easily addressed by coating each pendent sheet individually by pre-designing the composite sheet on a larger scale and then cutting the appropriate shapes from the larger composite sheet material. This would result in a pendent composite sheet as depicted in FIG. 8, which displays a cross-sectional view of the pendent composite sheet. Also shown is the infrared properties of the pendent composite sheet with distinct higher and lower infrared emissivity surfaces. The infrared spectrum is based on a polyethylene terephthalate coating on aluminium foil. In particular, 16 μm thick commercially available aluminium foil and 75 μm thick polyethylene terephthalate films were used as the lower and higher infrared emissivity materials respectively. The polyethylene terephthalate films were laminated on aluminium foil at 130° C. using a laminator. Investigative studies found that by increasing the number of polyethylene terephthalate layers, the infrared emissivity of the surface is increased (i.e. the surface of higher infrared emissivity is enhanced). The average infrared emissivity between 8-13 μm is 0.01 for the surface of lower infrared emissivity and 0.93 for the surface of higher infrared emissivity (using 3 polyethylene terephthalate layers).

As discussed hereinbefore, when a metal or metal foil is coated onto the surface of lower infrared emissivity, it is important to protect this side from mechanical wear by using an infrared transparent protecting layer. An appropriate infrared transparent protecting layer, such as polyethylene, is applied to the second surface of lower infrared emissivity of the pendent composite sheet, as shown by the cross-sectional diagram in FIG. 9.

The possibility of colouring the pendent composites sheets, which broadens the range of applications for the substrates of the present invention, was also considered. It is possible to apply specific visible appearances (colours) to the pendent composite sheets to enhance the aesthetics of the pendent composite sheets for applications such as camouflage. The commercial sample materials are available in a variety of colours most of which show higher infrared emissivity. As highlighted above, colouring the lower infrared emissivity surface, however, is challenging as colouring agents and dyes are typically higher infrared emissivity materials. This issue has been resolved in a number of ways. The first is using interference as a tool for colouration. For instance, ultrathin (˜20 nm) silicon coating on aluminium colours the surface without altering the infrared emissivity of the lower infrared emissivity surface. The surface colour can be modified by adjusting the silicon film thickness (shown as colouring surfaces (#1) in FIG. 10). An alternative for colouring the lower infrared emissivity surface is by coating with a colouring layer such as a dyed fabric and a transparent conductive layer, such as indium tin oxide, that is transparent in the visible region and exhibits low infrared emissivity (ε ˜0.15) (shown as colouring surfaces (#2) in FIG. 10). A third way of colouring the pendent composite sheets is by using a coloured higher infrared emissivity layer and a transparent conductive layer, such as indium tin oxide, that is transparent in the visible region and exhibits low infrared emissivity (shown as colouring surfaces (#3) in FIG. 10). A protection layer on the lower infrared emissivity side can be used for all three cases, as shown in FIG. 10. In all three cases of colouration, the layers can be deposited on the second surface of lower infrared emissivity by various physical vapour deposition and chemical vapour deposition techniques.

As shown in FIG. 11, an indium tin oxide coating on polyethylene terephthalate was used as the second surface of lower infrared emissivity. A polyvinylchloride polymer with a yellow colour was coated on as the first surface of higher infrared emissivity. The average infrared emissivity between the 8-13 μm wavelength range was 0.84 for the indium tin oxide coated surface and 0.96 for the polyvinylchloride polymer coated surface. Photographs of both the first surface of higher infrared emissivity and the second surface of lower infrared emissivity show the same surface colour as a result of the indium tin oxide, which is a transparent conductive material. The infrared emissivity contrast was captured by thermal imaging. The thermal imaging was performed as the sample was placed on a hot plate at 100° C.

As shown in FIG. 12, a fluorine tin oxide coating on glass was used as the second surface of lower infrared emissivity. A blue polyvinylchloride polymer was coated on as the first surface of higher infrared emissivity. The average infrared emissivity between the 8-13 μm wavelength range is 0.15 for the fluorine tin oxide coated surface and 0.96 for the polyvinylchloride polymer coated surface. Photographs of both the first surface of higher infrared emissivity and the second surface of lower infrared emissivity show similar surface colours as a result of the fluorine tin oxide, which is a transparent conductive material. The infrared emissivity contrast was captured by thermal imaging. The thermal imaging was performed as the sample was placed on a hot plate at 100° C.

The samples as shown in FIG. 13 were fabricated by coating 2 μm thick Parylene C on aluminium foils, then depositing various thickness platinum films on top of the Parylene surface. The infrared emissivity was observed to be a strong function of the platinum thickness as shown by the infrared emissivity spectra. The long-wave infrared emissivity range that can be attained by varying the platinum thickness was 0.1-0.9. For instance, to create a sequin material with an infrared emissivity value of 0.1 for the second surface of lower infrared emissivity and 0.9 for the first surface of higher infrared emissivity, 0 and 3 nm platinum films can be coated to the respective sides. The low and high infrared emissivity levels can be carefully adjusted to any two distinct levels with this method. Parylene C was deposited by chemical vapour deposition. Platinum was deposited by a sputter coating process.

While specific embodiments of the invention have been described herein for the purpose of reference and illustration, various modifications will be apparent to a person skilled in the art without departing from the scope of the invention as defined by the appended claims.
The project leading to this application has received funding from the European Research Council (ERC) under the European Union's Horizon 2020 research and innovation programme (grant agreement No 682723).

1. A substrate having a surface of variable infrared emissivity, wherein at least one surface of the substrate comprises a plurality of pendent composite sheets fixed thereto,
and wherein each pendent composite sheet comprises a first surface of higher infrared emissivity and a second surface of lower infrared emissivity, and
wherein each pendent composite sheet is independently fixed to the substrate and configured such that each sheet can be moved between a first position in which the first surface of higher infrared emissivity covers a portion of the surface of the substrate and a second position in which the second surface of lower infrared emissivity covers a portion of the surface of the substrate.

2. The substrate of claim 1, wherein the substrate is selected from the group consisting of textiles, non-woven textiles, fabric, polymeric material, a surface of an object or article, and a combination thereof.

3. The substrate of claim 2, wherein the fabric is selected from the group consisting of cotton, polyester, nylon and cloth.

4. The substrate of any one of claim 1, 2 or 3 wherein each pendent composite sheet is independently fixed to the substrate by a thread, a hook, a linker, a hinge, sewing means or a connecting member.

5. The substrate of any one of the preceding claims, wherein each pendent composite sheet comprises a first surface of higher infrared emissivity, wherein the first surface of higher infrared emissivity comprises at least one material selected from the group consisting of polymeric materials, fabrics, graphene and/or a dielectric layer of higher infrared emissivity.

6. The substrate of claim 5, wherein the polymeric material is selected from the group consisting of polyvinylchloride, polyethylene terephthalate, polyethylene, polypropylene, polystyrene, Nylon, Teflon, polyurethanes, polychlorotrifluoroethylene, poly(methyl methacrylate), polydimethylsiloxane, Parylene, glass and combinations thereof.

7. The substrate of claim 5, wherein the fabric is selected from a group consisting of cotton, polyester, silk and a combination thereof.

8. The substrate of any one of claims 5-7, wherein the first surface of higher infrared emissivity comprises at least one material selected from the group consisting of polymeric materials and/or fabrics, the coating on the first surface of higher infrared emissivity has a thickness of 1-300 μm.

9. The substrate of claim 5, wherein the graphene has a thickness of 5-250 layers of graphene.

10. The substrate of claim 5, wherein the dielectric layer of higher infrared emissivity comprises at least one metal layer, at least one polymeric material layer and at least one tuneable layer.

11. The substrate of any one of the preceding claims, wherein each pendent composite sheet comprises a second surface of lower infrared emissivity, wherein the second surface of lower infrared emissivity comprises at least one material selected from the group consisting of metals, metal foils, conductive oxides, graphene and/or a dielectric layer of lower infrared emissivity.

12. The substrate of claim 11, wherein the metal or metal foil is selected from the group consisting of gold, silver, aluminium, copper, nickel, steel, titanium, chromium, platinum and iron.

13. The substrate of claim 11, wherein the conductive oxide is indium tin oxide or fluorine tin oxide.

14. The substrate of any one of claims 11-13, wherein the second surface of lower infrared emissivity comprises at least one material selected from the group consisting of metals, metal foils and/or conductive oxides, the coating on the second surface of lower infrared emissivity has a thickness of 1-20000 nm.

15. The substrate of claim 11, wherein the graphene has a thickness of 100-1250 layers of graphene.

16. The substrate of claim 11, wherein the dielectric layer of lower infrared emissivity comprises at least one metal layer, at least one polymeric material layer and at least one tuneable layer.

17. The substrate of any one of the preceding claims, wherein each pendent composite sheet comprises an adhesion layer positioned between the layers forming the first surface of higher infrared emissivity and the second surface of lower infrared emissivity of the pendent composite sheet.

18. The substrate of claim 17, wherein the adhesion layer has a thickness of 1-10 nm.

19. The substrate of any one of the preceding claims, wherein each pendent composite sheet comprises a colouring layer.

20. The substrate of any one of the preceding claims, wherein each pendent composite sheet comprises a transparent conductive layer applied to the second surface of lower infrared emissivity.

21. The substrate of any one of the preceding claims, wherein each pendent composite sheet comprises an infrared transparent protecting layer applied to the second surface of lower infrared emissivity.

22. An object or article having a surface coated with a substrate having a surface of variable infrared emissivity as claimed in any one of the preceding claims.

23. A method of varying the infrared emissivity on a surface of a substrate according to any one of claims 1-21, the method comprising:
moving one or more pendent composite sheets between a first position in which the first surface of higher infrared emissivity covers a portion of the surface of the substrate and a second position in which the second surface of lower infrared emissivity covers a portion of the surface of the substrate, or vice versa.

24. The method of claim 23, wherein each pendent composite sheet is positioned in the first position whereby the first surface of high infrared emissivity covers a portion of the surface of the substrate such that the second surface of lower infrared emissivity is exposed to an external environment relative to the substrate; or
each pendent composite sheet is positioned in the second position whereby the second surface of lower infrared emissivity covers a portion of the surface of the substrate such that the first surface of higher infrared emissivity is exposed to an external environment relative to the substrate; or
each pendent composite sheet is independently positioned between the first and second positions.

25. Use of a substrate of any one of claims 1-21 for:
(i) dynamic thermal management by controlling the infrared emissivity of the surface of a substrate, wherein the use for dynamic thermal management by controlling the infrared emissivity of the surface of a substrate is according to the method of claim 23 or 24; or
(ii) camouflage technology infrared communication, wherein the use for camouflage technology infrared communication is according to the method of claim 23 or 24; or
(iii) a heat regulating protective cover, wherein the use for heat regulating protective covers is according to the method of claim 23 or 24.
